(19) United States
(12) Patent Application Publication
(10) Pub. No.: US 2025/0106924 A1
(43) Pub. Date: Mar. 27, 2025

(54) MOBILE INTEGRATED ACCESS AND BACKHAUL PROCEDURES BASED ON INTERFACE AVAILABILITY

(71) Applicant: QUALCOMM Incorporated, San Diego, CA (US)

(72) Inventors: Naeem AKL, Bridgewater, NJ (US); Karl Georg HAMPEL, Jersey City, NJ (US)

(21) Appl. No.: 18/810,960

(22) Filed: Aug. 21, 2024

Related U.S. Application Data
(60) Provisional application No. 63/585,941, filed on Sep. 27, 2023.

(51) Int. Cl. H04W 76/18; H04W 76/30; H04W 88/08

(52) U.S. Cl. CPC H04W 76/18; H04W 76/30; H04W 88/085

(57) ABSTRACT

Methods, systems, and devices for mobile integrated access and backhaul procedures based on interface availability are described. Some examples may provide approaches for blocking at least a portion of mobile Integrated Access and Backhaul (IAB) procedures when Xn connectivity is unavailable. Some aspects of the techniques may be performed in the context of mobile IAB node integration. For example, a second central unit (CU) may determine if Xn connectivity is available with a first CU. In a case that Xn connectivity is unavailable, the second CU may reject an F1 connection setup request or the second CU may accept the F1 connection setup request and trigger a DU migration to a different CU. Some aspects of the techniques may be performed in the context of mobile IAB-mobile termination (MT) migration. Some aspects of the techniques may be performed in the context of mobile IAB-distributed unit (DU) migration.

### CROSS REFERENCE

The present application for patent claims the benefit of U.S. Provisional Patent Application No. 63/585,941 by AKL et al., entitled “MOBILE INTEGRATED ACCESS AND BACKHAUL PROCEDURES BASED ON INTERFACE AVAILABILITY,” filed Sep. 27, 2023, assigned to the assignee hereof, and expressly incorporated by reference in its entirety herein.

### FIELD OF TECHNOLOGY

The following relates to wireless communication, including mobile integrated access and backhaul procedures based on interface availability.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some wireless communications systems may employ central units (CUs) and mobile integrated access and backhaul (IAB) nodes to provide communication service to one or more user equipments (UEs). A mobile IAB node may include a distributed unit (DU) and a mobile termination (MT). For example, a mobile IAB node may include a DU to communicate wirelessly with one or more UEs and an MT to communicate wirelessly with one or more CUs (e.g., donor CUs) of a core network. Some approaches may support integration of a mobile IAB node at separate radio resource control (RRC)-terminating and F1-terminating CUs. For instance, the MT may be associated with a first CU and the DU may be associated with a second CU, where the first CU may communicate with the MT of the mobile IAB node via an RRC connection and the second CU may communicate with the DU of the IAB node via an F1 connection. As used herein, an MT of an IAB node may be referred to as an “IAB-MT” and a DU of an IAB node may be referred to as an “IAB-DU.”

Some examples of the techniques described herein may provide approaches for blocking at least a portion of mobile IAB procedures when Xn connectivity is unavailable. Some aspects of the techniques described herein may be performed in the context of mobile IAB node integration. For example, an IAB node may initiate an F1 connection setup targeting a second CU. In this case, the IAB node may provide a next generation NodeB identity (gNB-ID) of a first CU to the second CU. The second CU may determine if Xn connectivity is available with the first CU. In a case that Xn connectivity is unavailable, the second CU may reject the F1 connection setup request or the second CU may accept the F1 connection setup request and trigger a DU migration to a different CU. A cause value (e.g., a cause value indicating the Xn connection unavailability) may be provided in a message to the IAB-DU.

Some aspects of the techniques described herein may be performed in the context of mobile IAB-MT migration. For example, the MT may migrate from a second CU to a third CU, while the IAB-DU is F1-connected to a first CU. If the target MT's CU (e.g., the third CU) has no Xn connectivity with the DU's CU (e.g., the first CU), the F1 connection of the IAB node may be released or a DU migration for the IAB node may be triggered. In some examples, with coordination among CUs, a source MT's CU (e.g., the second CU) may check with either the first CU or the third CU to determine whether the latter two CUs may have Xn connectivity. If not, the first CU may release the F1 connection or may trigger a DU migration. In some examples, with coordination via an IAB node, the IAB node may provide a gNB-ID of the third CU to the first CU. Based on the gNB-ID, the first CU may check to determine if an Xn connection is available with the third CU. If the Xn connection is unavailable, the first CU may release the F1 connection or may trigger a DU migration.

Some aspects of the techniques described herein may be performed in the context of mobile IAB-DU migration. For example, an IAB-MT may be connected to a first CU, CU A may be a source F1-terminating CU and CU B may be a target F1-terminating CU for the IAB node. In some examples, the IAB node may provide a gNB-ID of the first CU to CU B. CU B may check to determine whether CU B has Xn connectivity with the first CU. In a case that Xn connectivity is unavailable, the CU B may reject the F1 connection setup or may accept the F1 connection setup and trigger a subsequent DU migration. In some examples, the IAB node may report an outcome to CU A. The report may be provided in a case where DU migration was triggered by CU A (or may not be provided in a case of operations, administration, and maintenance (OAM)-initiated DU migration).

A method for wireless communications by a second CU is described. The method may include receiving a first indication of an identifier of a first CU that is connected to an access node via a backhaul UE interface connection and transmitting a second indication to the access node to suspend a backhaul network entity interface connection between the access node and the second CU, where the second indication to suspend the backhaul network entity interface connection is based on an inter-CU backhaul connection being unavailable between the second CU and the first CU.

A second CU for wireless communications is described. The second CU may include one or more memories storing processor executable code, and one or more processors coupled with the one or more memories. The one or more processors may individually or collectively operable to execute the code to cause the second CU to receive a first indication of an identifier of a first CU that is connected to an access node via a backhaul UE interface connection and transmit a second indication to the access node to suspend a backhaul network entity interface connection between the access node and the second CU, where the second indication to suspend the backhaul network entity interface connection is based on an inter-CU backhaul connection being unavailable between the second CU and the first CU.

Another second CU for wireless communications is described. The second CU may include means for receiving a first indication of an identifier of a first CU that is connected to an access node via a backhaul UE interface connection and means for transmitting a second indication to the access node to suspend a backhaul network entity interface connection between the access node and the second CU, where the second indication to suspend the backhaul network entity interface connection is based on an inter-CU backhaul connection being unavailable between the second CU and the first CU.

A non-transitory computer-readable medium storing code for wireless communications is described. The code may include instructions executable by a processor to receive a first indication of an identifier of a first CU that is connected to an access node via a backhaul UE interface connection and transmit a second indication to the access node to suspend a backhaul network entity interface connection between the access node and the second CU, where the second indication to suspend the backhaul network entity interface connection is based on an inter-CU backhaul connection being unavailable between the second CU and the first CU.

In some examples of the method, second CUs, and non-transitory computer-readable medium described herein, receiving the first indication may include operations, features, means, or instructions for receiving the first indication from the access node.

In some examples of the method, second CUs, and non-transitory computer-readable medium described herein, receiving the first indication may include operations, features, means, or instructions for receiving the first indication from a CU that terminates the backhaul UE interface connection for the access node.

In some examples of the method, second CUs, and non-transitory computer-readable medium described herein, the backhaul UE interface connection may be a RRC connection.

In some examples of the method, second CUs, and non-transitory computer-readable medium described herein, receiving the first indication may include operations, features, means, or instructions for receiving the first indication prior to an establishment of the backhaul UE interface connection, where the first indication may be associated with establishment of the backhaul UE interface connection to the first CU.

Some examples of the method, second CUs, and non-transitory computer-readable medium described herein may further include operations, features, means, or instructions for determining that the inter-CU backhaul connection may be unavailable based on a determination that inter-CU backhaul connectivity cannot be established.

In some examples of the method, second CUs, and non-transitory computer-readable medium described herein, the first indication includes a request to perform suspension of the backhaul network entity interface connection between the access node and the second CU indicated by the second indication.

Some examples of the method, second CUs, and non-transitory computer-readable medium described herein may further include operations, features, means, or instructions for suspending the backhaul network entity interface connection between the second CU and the access node by performing a release of the backhaul network entity interface connection.

In some examples of the method, second CUs, and non-transitory computer-readable medium described herein, the backhaul network entity interface connection between the second CU and the access node may be an F1 connection.

Some examples of the method, second CUs, and non-transitory computer-readable medium described herein may further include operations, features, means, or instructions for suspending the backhaul network entity interface connection between the second CU and the access node by rejecting a connection setup procedure initiated by the access node to the second CU and transmitting a rejection message indicating a redirection of the connection setup procedure to a different CU.

Some examples of the method, second CUs, and non-transitory computer-readable medium described herein may further include operations, features, means, or instructions for suspending the backhaul network entity interface connection between the second CU and the access node by triggering an establishment of a second backhaul network entity interface connection between the access node and a different CU than the second CU.

In some examples of the method, second CUs, and non-transitory computer-readable medium described herein, the second indication indicates a cause value associated with unavailability of the inter-CU backhaul connection between the second CU and the first CU.

A method for wireless communications by an access node is described. The method may include establishing a backhaul UE interface connection with a first CU, transmitting an identifier of the first CU to a second CU associated with a backhaul network entity interface connection between the second CU and the access node, and receiving, in response to transmitting the identifier of the first CU, an indication to suspend the backhaul network entity interface connection between the second CU and the access node.

An access node for wireless communications is described. The access node may include one or more memories storing processor executable code, and one or more processors coupled with the one or more memories. The one or more processors may individually or collectively operable to execute the code to cause the access node to establish a backhaul UE interface connection with a first CU, transmit an identifier of the first CU to a second CU associated with a backhaul network entity interface connection between the second CU and the access node, and receive, in response to transmitting the identifier of the first CU, an indication to suspend the backhaul network entity interface connection between the second CU and the access node.

Another access node for wireless communications is described. The access node may include means for establishing a backhaul UE interface connection with a first CU, means for transmitting an identifier of the first CU to a second CU associated with a backhaul network entity interface connection between the second CU and the access node, and means for receiving, in response to transmitting the identifier of the first CU, an indication to suspend the backhaul network entity interface connection between the second CU and the access node.

A non-transitory computer-readable medium storing code for wireless communications is described. The code may include instructions executable by a processor to establish a backhaul UE interface connection with a first CU, transmit an identifier of the first CU to a second CU associated with a backhaul network entity interface connection between the second CU and the access node, and receive, in response to transmitting the identifier of the first CU, an indication to suspend the backhaul network entity interface connection between the second CU and the access node.

In some examples of the method, access nodes, and non-transitory computer-readable medium described herein, the backhaul UE interface connection may be an RRC connection and the backhaul network entity interface connection may be an F1 connection.

In some examples of the method, access nodes, and non-transitory computer-readable medium described herein, the identifier may be transmitted in association with a request to establish the backhaul network entity interface connection.

In some examples of the method, access nodes, and non-transitory computer-readable medium described herein, the indication to suspend the backhaul network entity interface connection includes a rejection message indicating a redirection of a connection setup procedure to a different CU than the second CU.

In some examples of the method, access nodes, and non-transitory computer-readable medium described herein, the indication to suspend the backhaul network entity interface connection includes a trigger to establish a second backhaul network entity interface connection between the access node and a different CU than the second CU.

In some examples of the method, access nodes, and non-transitory computer-readable medium described herein, the indication to suspend the backhaul network entity interface connection includes a cause value indicating unavailability of an inter-CU backhaul connection between the first CU and the second CU.

Some examples of the method, access nodes, and non-transitory computer-readable medium described herein may further include operations, features, means, or instructions for transmitting, to a third CU, a message indicating suspension of the backhaul network entity interface connection between the second CU and the access node.

A method for wireless communications by a first CU is described. The method may include establishing a backhaul UE interface connection with an access node, establishing a transport for a backhaul network entity interface connection of the access node with a second CU within a topology of the first CU, transmitting a message initiating a migration of the backhaul UE interface connection of the access node from the first CU to a third CU, receiving a first indication of unavailability of an inter-CU backhaul connection between the second CU and the third CU, and transmitting a second indication to the second CU to release the backhaul network entity interface connection based on the first indication of unavailability of the inter-CU backhaul connection.

A first CU for wireless communications is described. The first CU may include one or more memories storing processor executable code, and one or more processors coupled with the one or more memories. The one or more processors may individually or collectively operable to execute the code to cause the first CU to establish a backhaul UE interface connection with an access node, establish a transport for a backhaul network entity interface connection of the access node with a second CU within a topology of the first CU, transmit a message initiating a migration of the backhaul UE interface connection of the access node from the first CU to a third CU, receive a first indication of unavailability of an inter-CU backhaul connection between the second CU and the third CU, and transmit a second indication to the second CU to release the backhaul network entity interface connection based on the first indication of unavailability of the inter-CU backhaul connection.

Another first CU for wireless communications is described. The first CU may include means for establishing a backhaul UE interface connection with an access node, means for establishing a transport for a backhaul network entity interface connection of the access node with a second CU within a topology of the first CU, means for transmitting a message initiating a migration of the backhaul UE interface connection of the access node from the first CU to a third CU, means for receiving a first indication of unavailability of an inter-CU backhaul connection between the second CU and the third CU, and means for transmitting a second indication to the second CU to release the backhaul network entity interface connection based on the first indication of unavailability of the inter-CU backhaul connection.

A non-transitory computer-readable medium storing code for wireless communications is described. The code may include instructions executable by a processor to establish a backhaul UE interface connection with an access node, establish a transport for a backhaul network entity interface connection of the access node with a second CU within a topology of the first CU, transmit a message initiating a migration of the backhaul UE interface connection of the access node from the first CU to a third CU, receive a first indication of unavailability of an inter-CU backhaul connection between the second CU and the third CU, and transmit a second indication to the second CU to release the backhaul network entity interface connection based on the first indication of unavailability of the inter-CU backhaul connection.

In some examples of the method, first CUs, and non-transitory computer-readable medium described herein, the backhaul UE interface connection may be an RRC connection and the backhaul network entity interface connection may be an F1 connection.

In some examples of the method, first CUs, and non-transitory computer-readable medium described herein, the migration may be a handover or a context retrieval for reestablishment.

In some examples of the method, first CUs, and non-transitory computer-readable medium described herein, the message initiating the migration may be carried on an Xn interface or an NG interface.

Some examples of the method, first CUs, and non-transitory computer-readable medium described herein may further include operations, features, means, or instructions for transmitting an identifier of the second CU to the third CU, where the first indication may be received based on transmitting the identifier of the second CU.

In some examples of the method, first CUs, and non-transitory computer-readable medium described herein, an indication of a connection release or a DU migration may be communicated via the backhaul network entity interface connection.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports mobile integrated access and backhaul procedures based on interface availability in accordance with one or more aspects of the present disclosure.

FIG. 2 shows an example of a network architecture that supports mobile integrated access and backhaul procedures based on interface availability in accordance with one or more aspects of the present disclosure.

FIG. 3 shows an example of a wireless communications system that supports mobile integrated access and backhaul procedures based on interface availability in accordance with one or more aspects of the present disclosure.

FIG. 4 shows an example of a process flow that supports mobile integrated access and backhaul procedures based on interface availability in accordance with one or more aspects of the present disclosure.

FIG. 5 shows an example of a process flow that supports mobile integrated access and backhaul procedures based on interface availability in accordance with one or more aspects of the present disclosure.

FIG. 6 shows an example of a process flow that supports mobile integrated access and backhaul procedures based on interface availability in accordance with one or more aspects of the present disclosure.

FIG. 7 shows an example of a process flow that supports mobile integrated access and backhaul procedures based on interface availability in accordance with one or more aspects of the present disclosure.

FIGS. 8 and 9 show block diagrams of devices that support mobile integrated access and backhaul procedures based on interface availability in accordance with one or more aspects of the present disclosure.

FIG. 10 shows a block diagram of a communications manager that supports mobile integrated access and backhaul procedures based on interface availability in accordance with one or more aspects of the present disclosure.

FIG. 11 shows a diagram of a system including a device that supports mobile integrated access and backhaul procedures based on interface availability in accordance with one or more aspects of the present disclosure.

FIGS. 12 and 13 show block diagrams of devices that support mobile integrated access and backhaul procedures based on interface availability in accordance with one or more aspects of the present disclosure.

FIG. 14 shows a block diagram of a communications manager that supports mobile integrated access and backhaul procedures based on interface availability in accordance with one or more aspects of the present disclosure.

FIG. 15 shows a diagram of a system including a device that supports mobile integrated access and backhaul procedures based on interface availability in accordance with one or more aspects of the present disclosure.

FIGS. 16 and 17 show block diagrams of devices that support mobile integrated access and backhaul procedures based on interface availability in accordance with one or more aspects of the present disclosure.

FIG. 18 shows a block diagram of a communications manager that supports mobile integrated access and backhaul procedures based on interface availability in accordance with one or more aspects of the present disclosure.

FIG. 19 shows a diagram of a system including a device that supports mobile integrated access and backhaul procedures based on interface availability in accordance with one or more aspects of the present disclosure.

FIGS. 20 through 25 show flowcharts illustrating methods that support mobile integrated access and backhaul procedures based on interface availability in accordance with one or more aspects of the present disclosure.

### DETAILED DESCRIPTION

Some wireless communications systems may employ central units (CUs) and mobile integrated access and backhaul (IAB) nodes to provide communication service to one or more user equipments (UEs). A mobile IAB node may include a distributed unit (DU) and a mobile termination (MT). In some examples, the mobile IAB node may be mounted on a vehicle (e.g., a car, a bus, or a train, among other examples) and may change geographic locations over time as the vehicle moves between locations. For example, a mobile IAB node may include a DU to communicate wirelessly with one or more UEs and an MT to communicate wirelessly with one or more CUs (e.g., donor CUs) of a core network. Some approaches may support integration of a mobile IAB node at separate radio resource control (RRC)-terminating and F1-terminating CUs. For instance, the MT may be associated with a first CU and the DU may be associated with a second CU, where the first CU may communicate with the MT of the mobile IAB node via an RRC connection and the second CU may communicate with the DU of the IAB node via an F1 connection. As used herein, an MT of an IAB node may be referred to as an “IAB-MT” and a DU of an IAB node may be referred to as an “IAB-DU.”

In a mobile IAB-MT migration procedure, the RRC-termination point of the mobile IAB-MT may be switched between different CUs, and one or more F1 connections of the mobile IAB node may be routed via a topology of a (target) mobile IAB-MT's CU. Sequential partial mobile IAB-MT migrations may be supported in some approaches. In a mobile IAB-DU migration procedure, the F1-termination point of the mobile IAB node may be switched between different CUs. In some examples, mobile IAB-DU migration may function by hosting multiple logical DUs at the IAB node. The mobile IAB-DU procedure may be triggered by an operations, administration, and maintenance (OAM) or mobile IAB node, or when a source IAB-DU's CU. UEs may also be handed over from a first IAB-DU cell to a second IAB-DU cell. Release of a source F1 connection may be optional in the IAB-DU migration procedure.

Coordination between IAB-donor-CUs may be utilized for several purposes. For example, coordination between CUs may be utilized to enable transport of F1 traffic of a DU's CU via the topology of an MT's CU (e.g., based on transport migration management (TMM) handshakes), to send an MT's user location information (ULI) to a DU's CU, or to indicate mobile IAB authorization status and status change to a DU's CU (which may be available at the MT's CU, for example), among other examples. Some coordination may be performed if an MT's CU and a DU's CU have Xn interface connectivity. However, some scenarios may occur where Xn connectivity is unavailable.

Some examples of the techniques described herein may provide approaches for blocking at least a portion of mobile IAB procedures when backhaul connectivity (e.g., Xn connectivity) is unavailable. Some aspects of the techniques described herein may be performed in the context of mobile IAB node integration. For example, an IAB node may initiate an F1 connection setup targeting a second CU. In this case, the IAB node may provide a next generation NodeB identity (gNB-ID) of a first CU to the second CU. The second CU may determine if Xn connectivity is available with the first CU. In a case that Xn connectivity is unavailable, the second CU may reject the F1 connection setup request or the second CU may accept the F1 connection setup request and trigger a DU migration to a different CU. A cause value (e.g., a cause value indicating the Xn connection unavailability) may be provided in a message to the IAB-DU.

Some aspects of the techniques described herein may be performed in the context of mobile IAB-MT migration. For example, the MT may migrate from a second CU to a third CU, while the IAB-DU is F1-connected to a first CU. If the target MT's CU (e.g., the third CU) has no Xn connectivity with the DU's CU (e.g., the first CU), the F1 connection of the IAB node may be released or a DU migration for the IAB node may be triggered. In some examples, with coordination among CUs, a source MT's CU (e.g., the second CU) may check with either the first CU or the third CU to determine whether the latter two CUs may have Xn connectivity. If not, the first CU may release the F1 connection or may trigger a DU migration. In some examples, with coordination via an IAB node, the IAB node may provide a gNB-ID of the third CU to the first CU. Based on the gNB-ID, the first CU may check to determine if an Xn connection is available with the third CU. If the Xn connection is unavailable, the first CU may release the F1 connection or may trigger a DU migration.

Some aspects of the techniques described herein may be performed in the context of mobile IAB-DU migration. For example, an IAB-MT may be connected to a first CU, CU A may be a source F1-terminating CU and CU B may be a target F1-terminating CU for the IAB node. In some examples, the IAB node may provide a gNB-ID of the first CU to CU B. CU B may check to determine whether CU B has Xn connectivity with the first CU. In a case that Xn connectivity is unavailable, the CU B may reject the F1 connection setup or may accept the F1 connection setup and trigger a subsequent DU migration. In some examples, the IAB node may report an outcome to CU A. The report may be provided in a case where DU migration was triggered by CU A (or may not be provided in a case of OAM-initiated DU migration).

Some examples of the techniques described herein may enable backhaul procedures in scenarios where an inter-CU interface (e.g., Xn interface connectivity) is unavailable. For instance, when an IAB node attempts to migrate an F1 connection between different carriers, an inter-CU interface may be unavailable between CUs of the different carriers. Some of the techniques described herein may enable migration redirection and F1 connection release while preserving one or more radio link connections for UEs being served by a mobile IAB node.

Aspects of the disclosure are initially described in the context of wireless communications systems. Aspects of the disclosure are also described in the context of process flow diagrams. Aspects of the disclosure are further illustrated by and described with reference to apparatus diagrams, system diagrams, and flowcharts that relate to mobile integrated access and backhaul procedures based on interface availability.

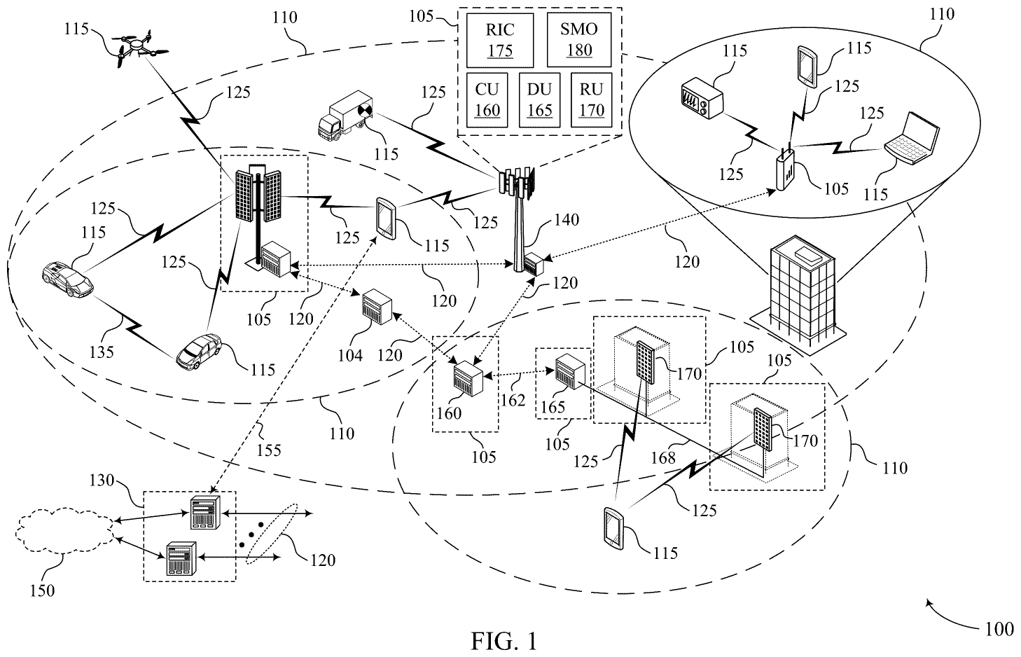

FIG. 1 shows an example of a wireless communications system 100 that supports mobile integrated access and backhaul procedures based on interface availability in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU 160, a DU 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support mobile integrated access and backhaul procedures based on interface availability as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some examples of the techniques described herein may provide approaches for blocking at least a portion of mobile IAB procedures when Xn connectivity is unavailable (e.g., use cases where inter-donor Internet protocol (IP) connectivity is unavailable). For scenarios without Xn connectivity, for example, IAB-related Xn signaling for partial migration or DU 165 migration may be carried via a connection (e.g., an NG connection, an RRC connection, or an F1 connection). In some examples, signaling may be carried using a container to reduce an impact on the AMF. For a case of DU 165 migration, for instance, F1 signaling from a target logical mobile IAB-DU may be utilized for providing an identifier (e.g., gNB-ID) of the mobile IAB-MT's CU 160 to the target mobile IAB-DU's CU 160.

Some aspects of the techniques described herein may be performed in the context of mobile IAB node 104 integration. For example, an IAB node 104 may initiate an F1 connection setup targeting a second CU 160. In this case, the IAB node 104 may provide a gNB-ID of a first CU 160 to the second CU 160. The second CU 160 may determine if Xn connectivity is available with the first CU 160. In a case that Xn connectivity is unavailable, the second CU 160 may reject the F1 connection setup request or the second CU 160 may accept the F1 connection setup request and trigger a DU 165 migration to a different CU 160. A cause value (e.g., a cause value indicating the Xn connection unavailability) may be provided in a message to the IAB-DU.

Some aspects of the techniques described herein may be performed in the context of mobile IAB-MT migration. For example, the MT may migrate from a second CU 160 to a third CU 160, while the IAB-DU is F1-connected to a first CU 160. If the target MT's CU 160 (e.g., the third CU 160) has no Xn connectivity with the DU's CU 160 (e.g., the first CU 160), the F1 connection of the IAB node 104 may be released or a DU 165 migration for the IAB node 104 may be triggered. In some examples, with coordination among CUs, a source MT's CU 160 (e.g., the second CU 160) may check with either the first CU 160 or the third CU 160 to determine whether the latter two CUs may have Xn connectivity. If not, the first CU 160 may release the F1 connection or may trigger a DU 165 migration. In some examples, with coordination via an IAB node 104, the IAB node 104 may provide a gNB-ID of the third CU 160 to the first CU 160. Based on the gNB-ID, the first CU 160 may check to determine if an Xn connection is available with the third CU 160. If the Xn connection is unavailable, the first CU 160 may release the F1 connection or may trigger a DU 165 migration.

Some aspects of the techniques described herein may be performed in the context of mobile IAB-DU migration. For example, an IAB-MT may be connected to a first CU 160, CU A may be a source F1-terminating CU 160 and CU B may be a target F1-terminating CU for the IAB node 104. In some examples, the IAB node 104 may provide a gNB-ID of the first CU 160 to CU B. CU B may check to determine whether CU B has Xn connectivity with the first CU 160. In a case that Xn connectivity is unavailable, the CU B may reject the F1 connection setup or may accept the F1 connection setup and trigger a subsequent DU 165 migration. In some examples, the IAB node 104 may report an outcome to CU A. The report may be provided in a case where DU 165 migration was triggered by CU A (or may not be provided in a case of OAM-initiated DU 165 migration).

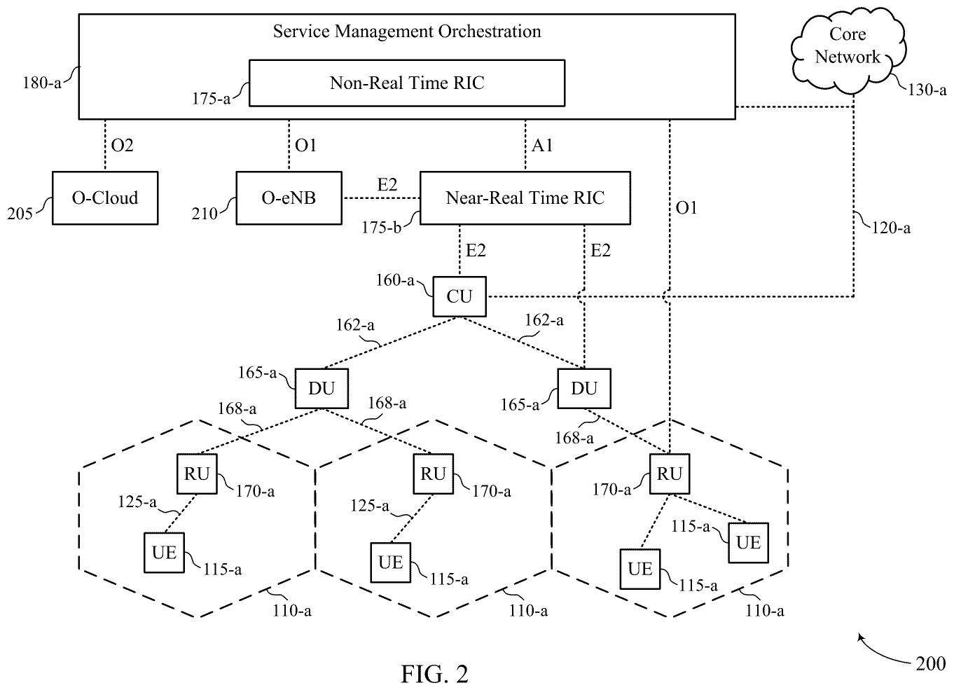

FIG. 2 shows an example of a network architecture 200 (e.g., a disaggregated base station architecture, a disaggregated RAN architecture) that supports mobile integrated access and backhaul procedures based on interface availability in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

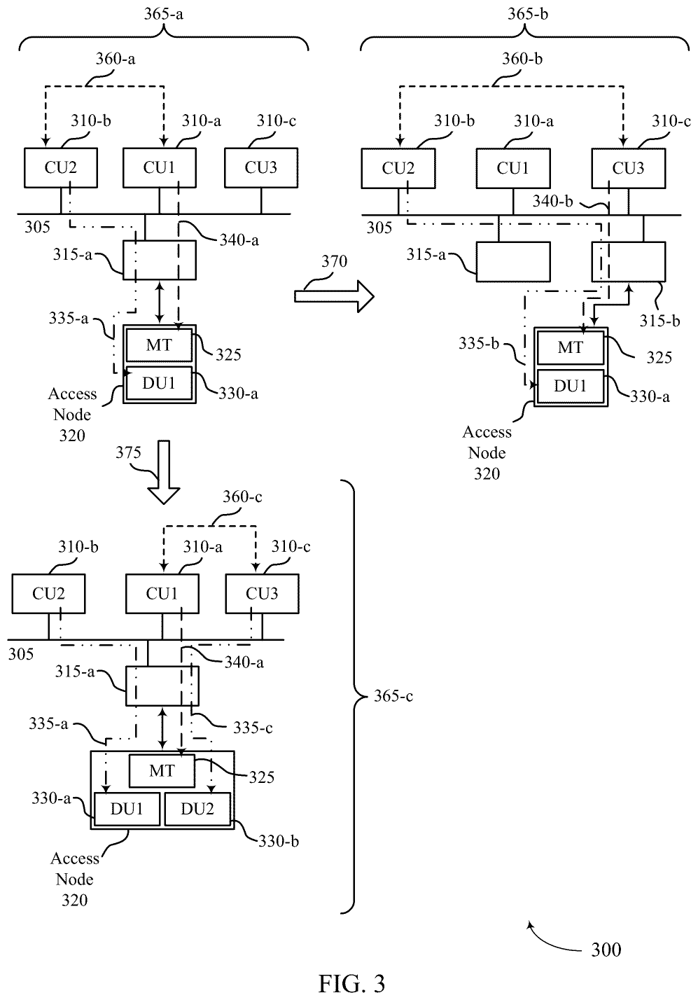

FIG. 3 shows an example of a wireless communications system 300 that supports mobile integrated access and backhaul procedures based on interface availability in accordance with one or more aspects of the present disclosure. In some examples, the wireless communications system 300 may implement or be implemented by aspects of the wireless communications system 100, the network architecture 200, or any combination thereof. For example, the wireless communications system 300 may include one or more network entities 105 and one or more UEs 115 (e.g., one or more UEs served by the access node 320), which may be examples of the corresponding devices described herein with reference to FIG. 1.

The wireless communications system 300 may include a first CU 310-a (e.g., CU1), a second CU 310-b (e.g., CU2), and a third CU 310-c (e.g., CU3) connected via a network 305. Additionally, a first donor DU 315-a (e.g., donor-DU1) and a second donor DU 315-b may be connected to the network 305, such that one or more of the CUs 310 may communicate with an access node 320 (e.g., IAB node) via the first donor DU 315-a or the second donor DU 315-b. Additionally, the access node 320 may include an MT 325 (e.g., IAB-MT), and one or more DUs, which may be referred to as a first DU 330-a (e.g., DU1, IAB-DU1) and a second DU 330-b (e.g., DU2, IAB-DU2). In the example of FIG. 3, the access node 320 may be an example of an IAB node 104; the first CU 310-a, the second CU 310-b, and the third CU 310-c may be examples of a CU 160; or the first donor DU 315-a, the second donor DU 315-b, the first DU 330-a, and the second DU 330-b may be examples of the DU 165.

Some examples of the techniques described herein may provide approaches for blocking at least a portion of mobile IAB procedures when inter-CU backhaul connectivity (e.g., Xn connectivity) is unavailable. Some aspects of the techniques described herein may be performed in the context of mobile IAB node integration. In some cases, integration of the access node 320 at separate terminating CUs may be supported. For example, the MT 325 may be associated with the first CU 310-a, and the first DU 330-a may be associated with the second CU 310-b. In some cases, the second CU 310-b may communicate with the first DU 330-a of the access node 320 via a first backhaul network entity interface connection 335-a (e.g., an F1 connection) through the first donor DU 315-a and the first CU 310-a may communicate with the MT 325 via a first backhaul UE interface connection 340-a (e.g., an RRC connection) through the first donor DU 315-a.

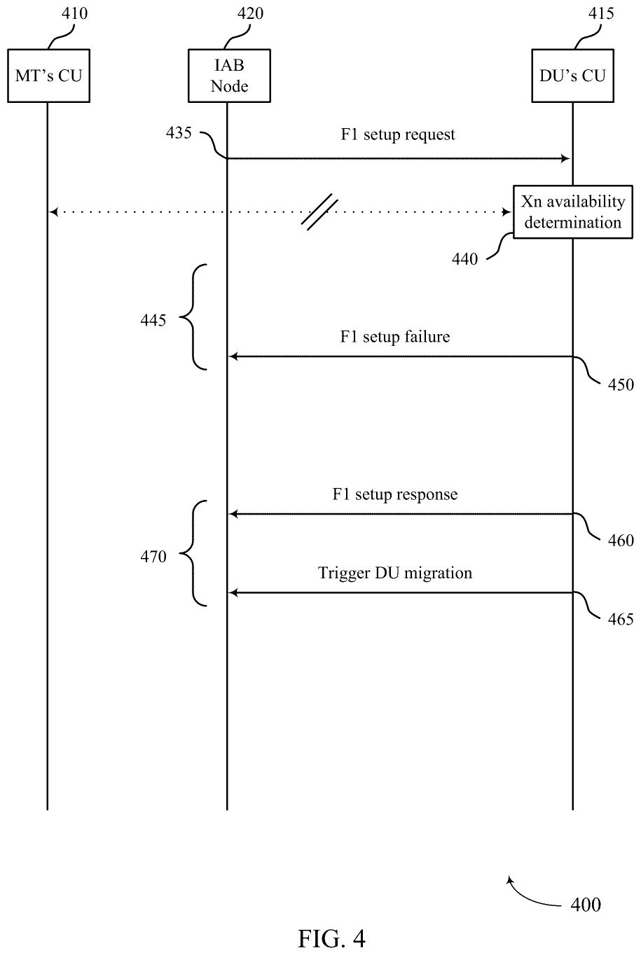

In a first scenario 365-a, the access node 320 may attempt to set up a first inter-CU backhaul connection 360-a between the second CU 310-b and the first CU 310-a. For example, the access node 320 may initiate an inter-CU backhaul network entity interface connection (e.g., F1 connection) setup targeting the second CU 310-b. In some approaches, the access node 320 may transmit an identifier (e.g., a gNB-ID) of the first CU 310-a to the second CU 310-b. The second CU 310-b may determine if inter-CU backhaul connectivity (e.g., a first inter-CU backhaul connection 360-a, an Xn connection) is available with the first CU 310-a. In a case that inter-CU backhaul connectivity is unavailable, the second CU 310-b may reject the backhaul network entity interface connection setup request, or the second CU 310-b may accept the backhaul network entity interface connection setup request and trigger a DU migration to a different CU. In some examples, a cause value (e.g., a cause value indicating the first inter-CU backhaul connection 360-a unavailability) may be provided in a message to the first DU 330-a (e.g., IAB-DU). A more specific example of integrated access and backhaul procedures in the context of access node integration is given with reference to FIG. 4.

Some aspects of the techniques described herein may be performed in the context of MT migration 370 (e.g., mobile IAB-MT migration). In the example of MT migration 370 illustrated in FIG. 3, the first backhaul UE interface connection 340-a of the access node 320 is migrated from the first CU 310-a to the third CU 310-c. In some examples, MT migration 370 may be performed in a handoff procedure, where the access node 320 switches from being served by the first donor DU 315-a to the second donor DU 315-b. As illustrated in FIG. 3, the first backhaul UE interface connection 340-a terminating at the first CU 310-a may be migrated to become the second backhaul UE interface connection 340-b terminating at the third CU 310-c.

In some examples of MT migration, the first backhaul network entity interface connection 335-a (carried over the first backhaul UE interface connection 340-a via the first donor DU 315-a) may be re-routed to become a second backhaul network entity interface connection 335-b (carried over the second backhaul UE interface connection 340-b via the second donor DU 315-b). For instance, the second backhaul network entity interface connection 335-b may be re-routed via the second donor DU 315-b and supported by the third CU 310-c, to be routed over the network 305 to maintain termination at the second CU 310-b.

In some examples, the wireless communications system 300 may support IAB TMM. For example, the second CU 310-b (e.g., CU2), which may be referred to as an F1-terminating CU (e.g., F1-terminating access node 320 donor), may be associated with a first donor DU 315-a. A third CU 310-c (e.g., CU3), which may be referred to as a non-F1-terminating CU (e.g., non-F1-terminating access node 320 donor), may be associated with a second donor DU 315-b (e.g., a second donor DU). The first donor DU 315-a may manage a topology including the second CU 310-b (e.g., F1-terminating CU), and the second donor DU 315-b may manage a topology associated with the third CU 310-c (e.g., non-F1-terminating CU). In some examples, both the second CU 310-b and the third CU 310-c may be capable of communicating via either the first donor DU 315-a or the second donor DU 315-b based on Internet protocol (IP) connectivity provided by the network 305 (e.g., an IP network). The first donor DU 315-a and the second donor DU 315-b may be associated with the access node 320 (e.g., a boundary access node 320). As described herein, the access node 320 may include the MT 325 (e.g., IAB-MT), and the first DU 330-a (e.g., IAB-DU).

In some cases, the second CU 310-b may communicate with the MT 325 via a first backhaul network entity interface connection 335-a through the first donor DU 315-a and may determine to offload traffic (e.g., a portion of the traffic or all of the traffic) with the MT 325 via the first donor DU 315-a to the second donor DU 315-b. As such, the second CU 310-b of the access node 320 and the third CU 310-c of the access node 320 may exchange information (e.g., via an IAB TMM procedure on behalf of the MT 325) to manage migration of a boundary and descendant access node 320 traffic between the topologies managed by the first donor DU 315-a and the second donor DU 315-b. In some examples, the second CU 310-b may initiate the IAB TMM procedure by transmitting an IAB TMM request message to the third CU 310-c. The third CU 310-c may respond with (e.g., transmit) an IAB TMM response message indicating traffic accepted or not accepted for offloading, already offloaded traffic accepted or not accepted for modification, or both.

Additionally, or alternatively, the wireless communications system 300 may support IAB transport migration (TM) modification. For example, the second CU 310-b and the third CU 310-c may perform an IAB TM modification procedure (e.g., on behalf of the MT 325) to modify backhaul information of offloaded traffic in the topology associated with the third CU 310-c (e.g., of the boundary access node 320). For instance, the IAB TM modification procedure may be used to release resources under the (e.g., associated with) the third CU 310-c used for serving the offloaded traffic. In some examples, the third CU 310-c may initiate the IAB Transport modification procedure by transmitting an IAB TM modification request message to the second CU 310-b. The second CU 310-b may respond with (e.g., transmit) an IAB TM modification response message or an IAB TMM response message.

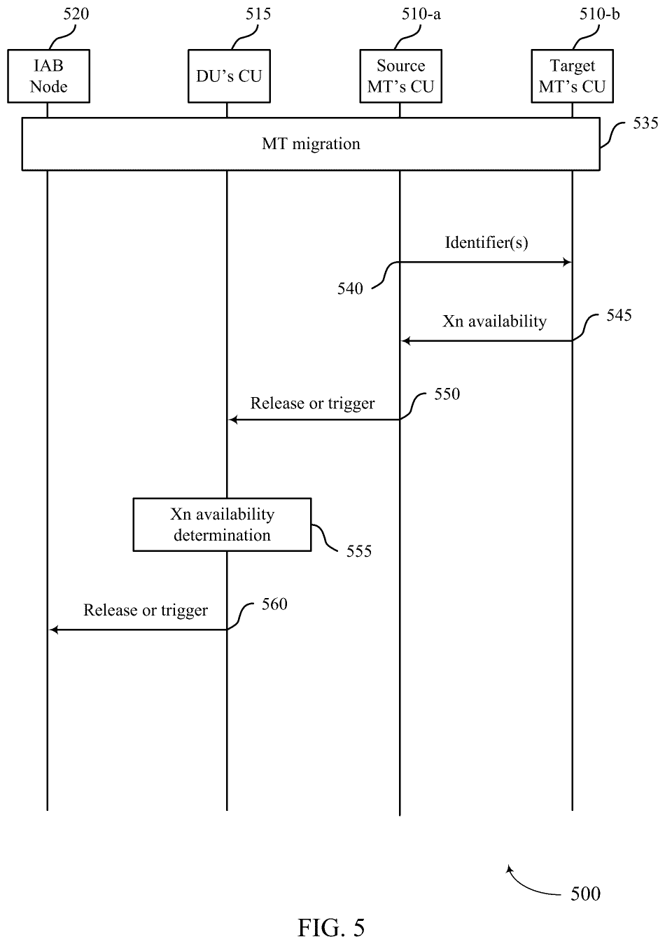

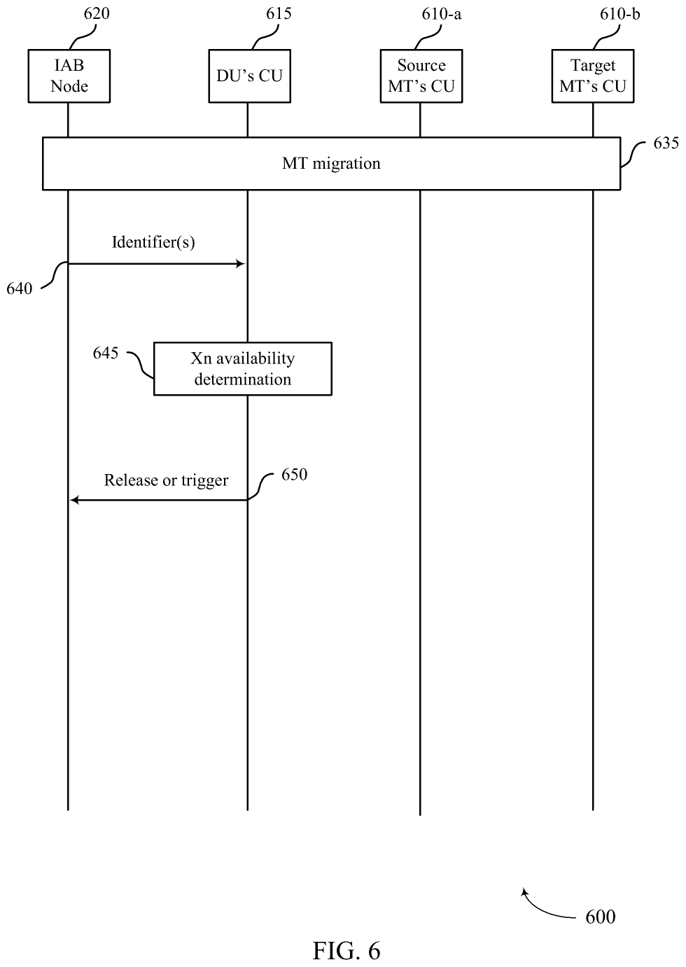

In a second scenario 365-b, the MT 325 may migrate from the first CU 310-a to the third CU 310-c, while the first DU 330-a (e.g., IAB-DU) has the first backhaul network entity interface connection 335-a (e.g., F1-connection) to the second CU 310-b. In a case that the third CU 310-c (e.g., the target MT's CU) does not have an available second inter-CU backhaul connection 360-b with the second CU 310-b (e.g., the DU's CU), the first backhaul network entity interface connection 335-a of the access node 320 may be released or a DU migration for the access node 320 may be triggered. In some examples, with coordination among CUs, a source MT's CU (e.g., the first CU 310-a) may check with the second CU 310-b or the third CU 310-c to determine whether the second CU 310-b or the third CU 310-c may have inter-CU backhaul connectivity. If not, the second CU 310-b may release the first backhaul network entity interface connection 335-a or may trigger a DU migration. In some examples, with coordination via an access node 320, the access node 320 may provide an identifier (e.g., a gNB-ID) of the third CU 310-c to the second CU 310-b. Based on the identifier, the second CU 310-b may check to determine if a second inter-CU backhaul connection 360-b is available with the third CU 310-c. If the inter-CU backhaul connection is unavailable, the second CU 310-b may release the first backhaul network entity interface connection 335-a or may trigger a DU migration. More specific examples of integrated access and backhaul procedures in the context of MT migration are given with reference to FIG. 5 and FIG. 6.

In a DU migration procedure 375, the termination point of the first DU 330-a may be switched between different CUs (e.g., between the second CU 310-b and the third CU 310-c). In some examples, mobile IAB-DU migration may function by hosting multiple logical DUs (e.g., the first DU 330-a and the second DU 330-b) at the access node 320. In some examples, the DU migration procedure may be triggered by an OAM or the access node 320, or when one or more UEs (e.g., UE 115-a) are handed over between DU cells.

In some examples of the DU migration procedure, the access node 320 may establish a third backhaul network entity interface connection 335-c with the third CU 310-c while connected to the second CU 310-b. For instance, the second DU 330-b may establish a third backhaul network entity interface connection 335-c (e.g., through the first donor DU 315-a) with the third CU 310-c while maintaining the first backhaul network entity interface connection 335-a with the second CU 310-b. While examples of the techniques described herein are provided in FIG. 3 in the context of DU migration, some examples of the techniques described herein may be performed without DU migration.

In some cases, CUs may not share a backhaul context or may not have inter-CU backhaul connectivity. For example, the first CU 310-a and the third CU 310-c, may not share a backhaul context (e.g., Xn context) associated with the MT 325. Additionally, or alternatively, the first CU 310-a and the third CU 310-c, may not have inter-CU backhaul connectivity (e.g., a third inter-CU backhaul connection 360-c, Xn connectivity). In some cases, CUs (e.g., the first CU 310-a and the third CU 310-c) may be unable to exchange (e.g., communicate, transmit) information via a third inter-CU backhaul connection 360-c (e.g., Xn connection).

Some aspects of the techniques described herein may be performed in the context of mobile IAB-DU migration. In a third scenario 365-c, for example, the MT 325 may be connected to the first CU 310-a. The second CU 310-b may be a source CU (e.g., source F1-terminating CU) and third CU 310-c may be a target CU (e.g., a target F1-terminating CU) for the access node 320. In some examples, the access node 320 may transmit an identifier (e.g., gNB-ID) of the first CU 310-a to third CU 310-c. The third CU 310-c may check to determine whether the third CU 310-c has inter-CU backhaul connectivity with the first CU 310-a. In a case that inter-CU backhaul connectivity (e.g., a third inter-CU backhaul connection 360-c) is unavailable, the third CU 310-c may reject the backhaul network entity interface connection setup or may accept the backhaul network entity interface connection setup and trigger a subsequent DU migration. In some examples, the access node 320 may report an outcome to the second CU 310-b. The report may be provided in a case where DU migration was triggered by second CU 310-b (or may not be provided in a case of OAM-initiated DU migration).

Some aspects of the techniques described herein are provided from a perspective of the second CU 310-b as follows. The second CU 310-b may receive a first indication of an identifier of the first CU 310-a that is connected to an access node 320 via the backhaul UE interface connection 340-a (e.g., an RRC connection). The first indication may indicate a connection setup request or a connection suspension request in some cases. The F1 setup request described with reference to FIG. 4, the identifier(s) described with reference to FIG. 5, or the identifier(s) described with reference to FIG. 6 may be examples of the first indication. The identifier may be a gNB-ID of the first CU 310-a in some approaches.

In some aspects, receiving the first indication may include receiving the first indication from the access node 320. For instance, the access node 320 may transmit the first indication to the second CU 310-b via the network 305.

In some examples, receiving the first indication may include receiving the first indication from a CU (e.g., from the first CU 310-a) that terminates the first backhaul UE interface connection 340-a for the access node 320. In the example of FIG. 3, the first CU 310-a may transmit the first indication to the second CU 310-b via the network 305.

In some approaches, the first indication may be received prior to an establishment of the first backhaul UE interface connection 340-a. The first indication may be associated with the establishment of the first backhaul UE interface connection 340-a (e.g., the RRC connection) to the first CU 310-a. For example, the first indication may be included in messaging utilized to set up to the first backhaul UE interface connection 340-a.

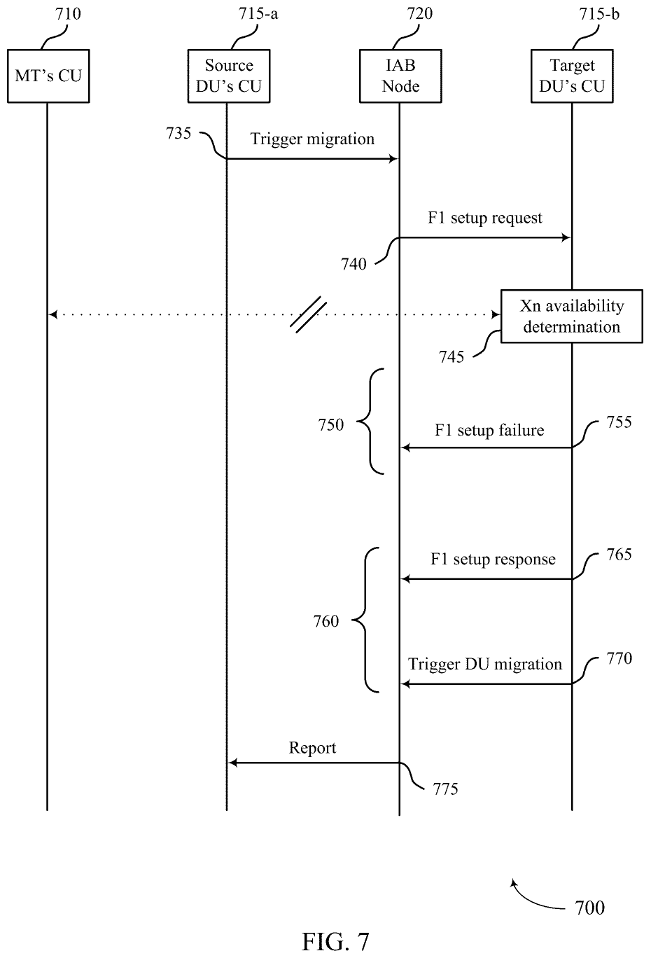

In some examples, the second CU 310-b may determine whether an inter-CU backhaul connection may be established. For instance, the second CU 310-b may determine that the first inter-CU backhaul connection 360-a is unavailable based on a determination that inter-CU backhaul connectivity cannot be established. In some aspects, the second CU 310-b may determine whether inter-CU backhaul connectivity can be established by attempting to set up an inter-CU backhaul connection with the first CU 310-a. For instance, the second CU 310-b may send one or more messages to the first CU 310-a (using the identifier, for example) requesting the establishment of inter-CU backhaul connectivity (e.g., requesting the first inter-CU backhaul connection 360-a). In a case that the second CU 310-b receives a message rejecting the request to establish inter-CU backhaul connectivity or in a case that the second CU 310-b does not receive a response within a threshold period of time, the second CU 310-b may determine that inter-CU backhaul connectivity cannot be established and that the first inter-CU backhaul connection 360-a is unavailable. The Xn availability determinations described with reference to FIG. 4, FIG. 5, FIG. 6, or FIG. 7 may be examples of determining whether an inter-CU backhaul connection may be established.

In some approaches, the second CU 310-b may maintain data or may query data from another source indicating whether the first inter-CU backhaul connection 360-a with the first CU 310-a is permitted. In a case that the data (e.g., a list of permitted or prohibited CUs for inter-CU backhaul connection) indicates that the first inter-CU backhaul connection 360-a is prohibited, the second CU 310-b may determine that inter-CU backhaul connectivity cannot be established and that the first inter-CU backhaul connection 360-a is unavailable.

The second CU 310-b may transmit a second indication to the access node 320 to suspend the first backhaul network entity interface connection 335-a between the access node 320 and the second CU 310-b. In some examples, the second indication to suspend the first backhaul network entity interface connection 335-a may be based on an inter-CU backhaul connection (e.g., the first inter-CU backhaul connection 360-a) being unavailable between the second CU 310-b and the first CU 310-a. For instance, the second CU 310-b may send the second indication in response to the determination that the first inter-CU backhaul connection 360-a is unavailable. The first backhaul network entity interface connection between the second CU 310-b and the access node 320 may be an F1 connection in some examples. The second indication may indicate a cause value associated with the unavailability of the first inter-CU backhaul connection 360-a between the second CU 310-b and the first CU 310-a. The F1 setup failure, F1 setup response, the DU migration trigger, or the release or trigger messages described with reference to FIG. 4, FIG. 5, FIG. 6, or FIG. 7 may be examples of the second indication.

In some aspects, the first indication includes a request to perform suspension of the backhaul network entity interface connection between the access node 320 and the second CU 310-b indicated by the second indication. For instance, the second CU 310-b may receive the first indication (including the request to perform suspension) and may transmit the second indication to the access node 320 to suspend the first backhaul network entity interface connection 335-a.

In some examples, the second CU 310-b may suspend the first backhaul network entity interface connection 335-a between the second CU 310-b and the access node 320 by performing a release of the first backhaul network entity interface connection 335-a (e.g., F1 connection). For example, the second CU 310-b may send or receive one or more signals to indicate or coordinate the release with the access node 320. In some examples, the release may be an orderly release, where the first backhaul network entity interface connection 335-a is released while one or more UEs connected to the access node 320 are handed over to another CU to avoid a radio link failure. For instance, the release may allow the access node 320 to set up a backhaul network entity interface connection with another CU.

In some examples, the second CU 310-b may suspend the first backhaul network entity interface connection 335-a between the second CU 310-b and the access node 320 by rejecting a connection setup procedure initiated by the access node 320 to the second CU 310-b. For instance, the access node 320 may initiate a setup procedure for the first backhaul network entity interface connection 335-a by sending one or more messages to the second CU 310-b. The second CU 310-b may transmit a rejection message to the access node 320 to suspend the first backhaul network entity interface connection 335-a. In some examples, the second CU 310-b may transmit a rejection message indicating a redirection of the connection setup procedure to a different CU. For instance, the rejection message may request that the access node 320 initiate the connection setup procedure with a different CU or may indicate an identifier of one or more CUs with which the access node 320 may attempt to set up a connection.

In some examples, the second CU 310-b may suspend the backhaul network entity interface connection between the second CU 310-b and the access node 320 by triggering an establishment of a another backhaul network entity interface connection between the access node 320 and a different CU than the second CU 310-b. For instance, the second CU 310-b may trigger the establishment of the third backhaul network entity interface connection 335-c between the access node 320 and the third CU 310-c. Triggering the establishment of another backhaul network entity interface connection may include sending one or more messages to the access node 320 or to one or more other CUs to initiate the establishment of the other backhaul network entity interface connection.

Some aspects of the techniques described herein are provided from a perspective of the access node 320 as follows. The access node 320 may establish a first backhaul UE interface connection 340-a (e.g., an RRC connection) with a first CU 310-a (or a second backhaul UE interface connection 340-b with the third CU 310-c, for example). For instance, the access node 320 may send one or more messages to the first CU 310-a or may receive one or more messages from the first CU 310-a to establish the first backhaul UE interface connection 340-a.

The access node 320 may transmit an identifier of the first CU 310-a to a second CU 310-b associated with the first backhaul network entity interface connection 335-a (e.g., an F1 connection) between the second CU 310-b and the access node 320. In some examples, the identifier may be transmitted in association with a request to establish the first backhaul network entity interface connection 335-a. The F1 setup request described with reference to FIG. 4 or the identifier(s) described with reference to FIG. 6 may be examples of the identifier or may be associated with the identifier.

The access node 320 may receive, in response to transmitting the identifier of the first CU 310-a, an indication to suspend the backhaul network entity interface connection between the second CU 310-b and the access node 320. The F1 setup failure, F1 setup response, the DU migration trigger, or the release or trigger messages described with reference to FIG. 4 or FIG. 6 may be examples of the second indication.

In some aspects, the indication to suspend the backhaul network entity interface connection may include a rejection message indicating a redirection of a connection setup procedure to a different CU than the second CU 310-b. The indication to suspend the backhaul network entity interface connection may include a trigger to establish a second backhaul network entity interface connection between the access node 320 and a different CU than the second CU 310-b. The indication to suspend the backhaul network entity interface connection may include a cause value indicating unavailability of an inter-CU backhaul connection between the first CU 310-a and the second CU 310-b. In some aspects, the access node 320 may transmit, to the third CU 310-c, a message indicating suspension of the backhaul network entity interface connection between the second CU 310-b and the access node 320.

Some aspects of the techniques described herein are provided from a perspective of the first CU 310-a as follows. The first CU 310-a may establish the first backhaul UE interface connection 340-a (e.g., an RRC connection) with the access node 320. For instance, the first CU 310-a may send one or more messages to the access node 320 or may receive one or more messages from the access node 320 to establish the first backhaul UE interface connection 340-a.

The first CU 310-a may establish a transport for a backhaul network entity interface connection 335-a (e.g., an F1 connection) of the access node 320 with the second CU 310-b within a topology of the first CU 310-a. For instance, the first CU 310-a may set up a transport channel to route communications between the access node 320 and the second CU 310-b.

The first CU 310-a may transmit a message initiating a migration of the first backhaul UE interface connection 340-a of the access node 320 from the first CU 310-a to the third CU 310-c. For instance, the migration may be a handover or a context retrieval for reestablishment (e.g., connection reestablishment). In some examples, the message initiating the migration may be carried on an inter-CU backhaul connection (e.g., Xn interface) or an NG interface. The MT migrations described with reference to FIG. 5 or FIG. 6 may be examples of the migration.

The first CU 310-a may receive a first indication of unavailability of a second inter-CU backhaul connection 360-b between the second CU 310-b and the third CU 310-c. In some examples, the first CU 310-a may transmit an identifier of the second CU 310-b to the third CU 310-c. The first indication may be received based on (e.g., in response to) transmitting the identifier of the second CU 310-b.

The first CU 310-a may transmit a second indication to the second CU 310-b to release the first backhaul network entity interface connection 335-a based on the first indication of unavailability of the second inter-CU backhaul connection 360-b. In some examples, an indication of a connection release or a DU migration may be communicated via the first backhaul network entity interface connection 335-a. While some examples are provided in the context of the scenarios of FIG. 3, the techniques described may be performed with one or more other entities (e.g., one or more other CUs, DUs, or access nodes), one or more other connections, or one or more other scenarios.

FIG. 4 shows an example of a process flow 400 that supports mobile integrated access and backhaul procedures based on interface availability in accordance with one or more aspects of the present disclosure. In some examples, the process flow 400 may implement or be implemented by aspects of the wireless communications system 100, the network architecture 200, the wireless communications system 300, or any combination thereof. For example, the process flow 400 may include one or more network entities 105 and one or more UEs 115, which may be examples of the corresponding devices described herein with reference to FIG. 1.

In some examples, a wireless communications system may include an IAB node 420, an MT's CU 410, and a DU's CU 415. In the example of FIG. 4, the IAB node 420 may be an example of an IAB node 104 or an access node 320; the MT's CU 410 may be an example of a CU 160, a CU 160-a or a first CU 310-a; or the DU's CU 415 may be an example of a CU 160, a CU 160-a, or a second CU 310-b.

The examples of FIG. 4 may illustrate examples of some of the techniques described herein in the context of mobile IAB node integration. At 435, the IAB node 420 may transmit an F1 setup request to the DU's CU 410. In some examples, the F1 setup request may include an identifier (e.g., a gNB-ID) of the MT's CU 410. The F1 setup request may be an example of an identifier as described with reference to FIG. 3.

At 440, the DU's CU 415 may perform an Xn availability determination. In some examples, the Xn availability determination may be performed as described with reference to FIG. 3. For instance, the DU's CU 415 may determine that an Xn connection is not available or cannot be established with the MT's CU.

At 450, the DU's CU 415 may transmit an F1 setup failure message in a first approach 445. For example, the DU's CU 415 may send one or more messages indicating a failure to set up an F1 connection, indicating that an Xn connection is unavailable, or a redirection to another CU.

At 460, the DU's CU 415 may transmit an F1 setup response in a second approach 470. For example, the DU's CU 415 may send one or more messages indicating that an F1 connection is set up (e.g., set up temporarily).

At 465, the DU's CU 415 may transmit a trigger for DU migration. For instance, the DU's CU 415 may transmit one or more messages to initiate a DU migration of the IAB node 420 to another donor (e.g., another CU). The F1 setup failure message or the F1 setup response with a trigger for DU migration may be examples of suspension as described with reference to FIG. 3.

FIG. 5 shows an example of a process flow 500 that supports mobile integrated access and backhaul procedures based on interface availability in accordance with one or more aspects of the present disclosure. In some examples, the process flow 500 may implement or be implemented by aspects of the wireless communications system 100, the network architecture 200, the wireless communications system 300, or any combination thereof. For example, the process flow 500 may include one or more network entities 105 and one or more UEs 115, which may be examples of the corresponding devices described herein with reference to FIG. 1.

In some examples, a wireless communications system may include an IAB node 520, a source MT's CU 510-a, a target MT's CU 510-b, and a DU's CU 515. In the example of FIG. 5, the IAB node 520 may be an example of an IAB node 104 or an access node 320; the source MT's CU 510-a may be an example of a CU 160, a CU 160-a or a first CU 310-a; the target MT's CU 510-b may be an example of a CU 160, a CU 160-a or a third CU 310-c; or the DU's CU 515 may be an example of a CU 160, a CU 160-a, or a second CU 310-b.

The examples of FIG. 5 may illustrate examples of some of the techniques described herein in the context of mobile IAB-MT migration. For instance, some of the procedures of FIG. 5 may be included in a variation (e.g., a CU-based variation) of techniques for backhaul procedures.

At 535, one or more of the IAB node 520, the DU's CU 515, the source MT's CU 510-a, or the target MT's CU 510-b may perform one or more of the operations described herein with relation to MT migration. For instance, MT migration (e.g., handover or connection reestablishment, via an Xn connection or an NG connection) may be performed from the source MT's CU 510-a to the target MT's CU 510-b. In some examples, the source MT's CU 510-a may transmit an identifier of the DU's CU 515 to the target MT's CU 510-b at 540 or may receive an indication of Xn availability between the DU's CU 515 and the target MT's CU 510-b at 545. In some approaches, the communication of the identifier or the Xn availability may be part of a handover preparation procedure between the source MT's CU 510-a and target MT's CU 510-b.

At 550, the source MT's CU 510-a may transmit one or more messages to the DU's CU 515. For example, the source MT's CU 510-a may transmit an identifier of the target MT's CU 510-b or an indication to release an F1 connection or to trigger a DU migration.

At 555, the DU's CU 515 may perform an Xn availability determination. In some examples, the Xn availability determination may be performed as described with reference to FIG. 3. For instance, the DU's CU 515 may determine that an Xn connection is not available or cannot be established with the target MT's CU 510-b.

At 560, the DU's CU 515 may transmit one or more messages to release an F1 connection or to trigger a DU migration. For instance, the DU's CU 515 may transmit one or more messages to initiate a DU migration of the IAB node 520 to another donor (e.g., another CU). The release or trigger message(s) may be examples of suspension as described with reference to FIG. 3.

FIG. 6 shows an example of a process flow 600 that supports mobile integrated access and backhaul procedures based on interface availability in accordance with one or more aspects of the present disclosure. In some examples, the process flow 600 may implement or be implemented by aspects of the wireless communications system 100, the network architecture 200, the wireless communications system 300, or any combination thereof. For example, the process flow 600 may include one or more network entities 105 and one or more UEs 115, which may be examples of the corresponding devices described herein with reference to FIG. 1.

In some examples, a wireless communications system may include an IAB node 620, a source MT's CU 610-a, a target MT's CU 610-b, and a DU's CU 615. In the example of FIG. 6, the IAB node 620 may be an example of an IAB node 104 or an access node 320; the source MT's CU 610-a may be an example of a CU 160, a CU 160-a or a first CU 310-a; the target MT's CU 610-b may be an example of a CU 160, a CU 160-a or a third CU 310-c; or the DU's CU 615 may be an example of a CU 160, a CU 160-a, or a second CU 310-b.

The examples of FIG. 6 may illustrate examples of some of the techniques described herein in the context of mobile IAB-MT migration. For instance, some of the procedures of FIG. 6 may be included in a variation (e.g., a IAB node-based variation) of techniques for backhaul procedures.

At 635, one or more of the IAB node 620, the DU's CU 615, the source MT's CU 610-a, or the target MT's CU 610-b may perform one or more of the operations described herein with relation to MT migration. For instance, MT migration (e.g., handover or connection reestablishment, via an Xn connection or an NG connection) may be performed from the source MT's CU 610-a to the target MT's CU 610-b.

At 640, the IAB node 620 may transmit one or more identifiers to the DU's CU 615. For example, the source IAB node 620 may transmit an identifier (e.g., gNB-ID) of the target MT's CU 610-b (e.g., via an F1 connection).

At 645, the DU's CU 615 may perform an Xn availability determination. In some examples, the Xn availability determination may be performed as described with reference to FIG. 3. For instance, the DU's CU 615 may determine that an Xn connection is not available or cannot be established with the target MT's CU 610-b.

At 650, the DU's CU 615 may transmit one or more messages to release an F1 connection or to trigger a DU migration. For instance, the DU's CU 615 may transmit one or more messages to initiate a DU migration of the IAB node 620 to another donor (e.g., another CU). The release or trigger message(s) may be examples of suspension as described with reference to FIG. 3.

FIG. 7 shows an example of a process flow 700 that supports mobile integrated access and backhaul procedures based on interface availability in accordance with one or more aspects of the present disclosure. In some examples, the process flow 700 may implement or be implemented by aspects of the wireless communications system 100, the network architecture 200, the wireless communications system 300, or any combination thereof. For example, the process flow 700 may include one or more network entities 105 and one or more UEs 115, which may be examples of the corresponding devices described herein with reference to FIG. 1.

In some examples, a wireless communications system may include an IAB node 720, a source DU's CU 715-a, a target DU's CU 715-b, and a MT's CU 710. In the example of FIG. 7, the IAB node 720 may be an example of an IAB node 104 or an access node 320; the source DU's CU 715-a may be an example of a CU 160, a CU 160-a or a second CU 310-b; the target DU's CU 715-b may be an example of a CU 160, a CU 160-a or a third CU 310-c; or the MT's CU 710 may be an example of a CU 160, a CU 160-a, or a first CU 310-a. The examples of FIG. 7 may illustrate examples of some of the techniques described herein in the context of mobile IAB-DU migration.

At 735, the source DU's CU 715-a may transmit one or more messages to trigger a DU migration. For instance, the source DU's CU 715-a may transmit one or more messages to initiate a DU migration of the IAB node 720 to the target DU's CU 715-b.

At 740, the IAB node 720 may transmit an F1 setup request to the target DU's CU 715-b. For instance, the IAB node 720 may transmit an F1 setup request including an identifier (e.g., a gNB-ID) of the MT's CU 710 to the target DU's CU 715-b.

At 745, the target DU's CU 715-b may perform an Xn availability determination. In some examples, the Xn availability determination may be performed as described with reference to FIG. 3. For instance, the target DU's CU 710 may determine that an Xn connection is not available or cannot be established with the target MT's CU 715-b.

At 755, the target DU's CU 715-b may transmit an F1 setup failure message in a first approach 750. For example, the target DU's CU 715-b may send one or more messages indicating a failure to set up an F1 connection, indicating that an Xn connection is unavailable, or a redirection to another CU.

At 765, the target DU's CU 715-b may transmit an F1 setup response in a second approach 760. For example, the target DU's CU 715-b may send one or more messages indicating that an F1 connection is set up (e.g., set up temporarily).

At 770, the target DU's CU 715-b may transmit a trigger for DU migration. For instance, the target DU's CU 715-b may transmit one or more messages to initiate a DU migration of the IAB node 720 to another donor (e.g., another CU). The F1 setup failure message or the F1 setup response with a trigger for DU migration may be examples of suspension as described with reference to FIG. 3.

At 775, the IAB node 720 may transmit a report to the source DU's CU 715-a. For instance, the IAB node 720 may report an outcome of the F1 connection setup (e.g., failure), that an Xn connection was unavailable, that the IAB node 720 has been redirected, or that migration has been triggered. In some aspects, the report may be provided in a case where DU migration was triggered by the source DU's CU 715-a, or the report may not be provided in a case of OAM-initiated DU migration in some cases. In some examples, the report may be transmitted for the first approach 750 or the second approach 760 (e.g., in accordance with timing for the first approach 750 or the second approach 760).

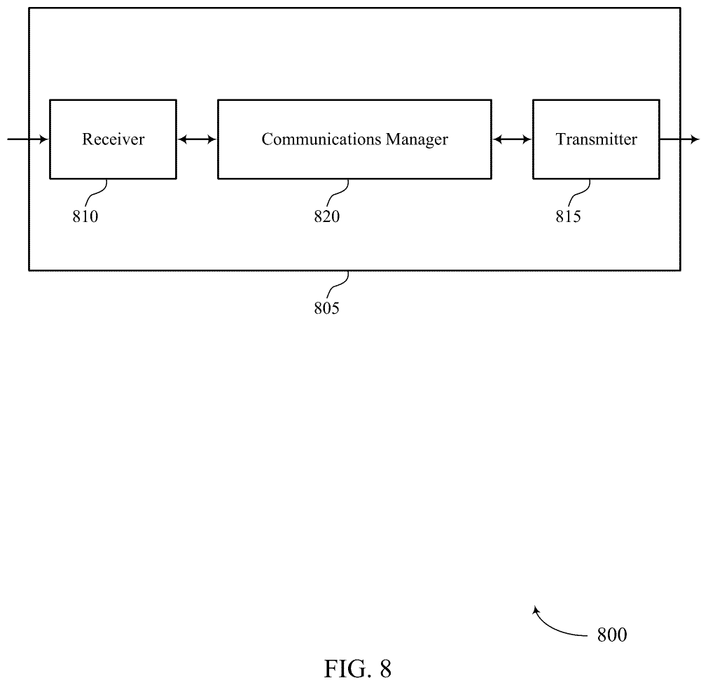

FIG. 8 shows a block diagram 800 of a device 805 that supports mobile integrated access and backhaul procedures based on interface availability in accordance with one or more aspects of the present disclosure. The device 805 may be an example of aspects of a second CU as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of mobile integrated access and backhaul procedures based on interface availability as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a first indication of an identifier of a first CU that is connected to an access node via a backhaul UE interface connection. The communications manager 820 is capable of, configured to, or operable to support a means for transmitting a second indication to the access node to suspend a backhaul network entity interface connection between the access node and the second CU, where the second indication to suspend the backhaul network entity interface connection is based on an inter-CU backhaul connection being unavailable between the second CU and the first CU.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

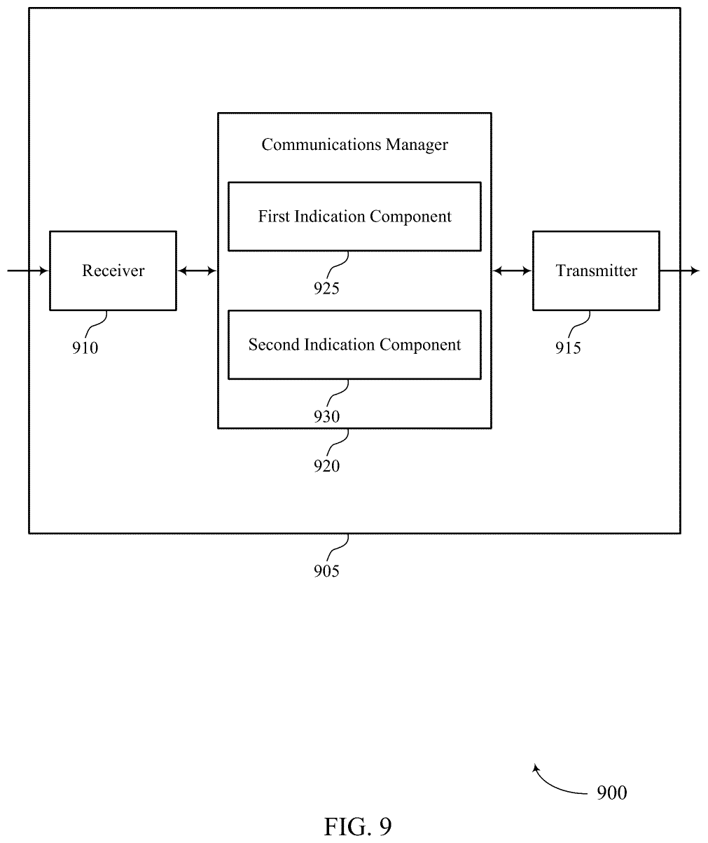

FIG. 9 shows a block diagram 900 of a device 905 that supports mobile integrated access and backhaul procedures based on interface availability in accordance with one or more aspects of the present disclosure. The device 905 may be an example of aspects of a device 805 or a second CU as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of mobile integrated access and backhaul procedures based on interface availability as described herein. For example, the communications manager 920 may include a first indication component 925 a second indication component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The first indication component 925 is capable of, configured to, or operable to support a means for receiving a first indication of an identifier of a first CU that is connected to an access node via a backhaul UE interface connection. The second indication component 930 is capable of, configured to, or operable to support a means for transmitting a second indication to the access node to suspend a backhaul network entity interface connection between the access node and the second CU, where the second indication to suspend the backhaul network entity interface connection is based on an inter-CU backhaul connection being unavailable between the second CU and the first CU.

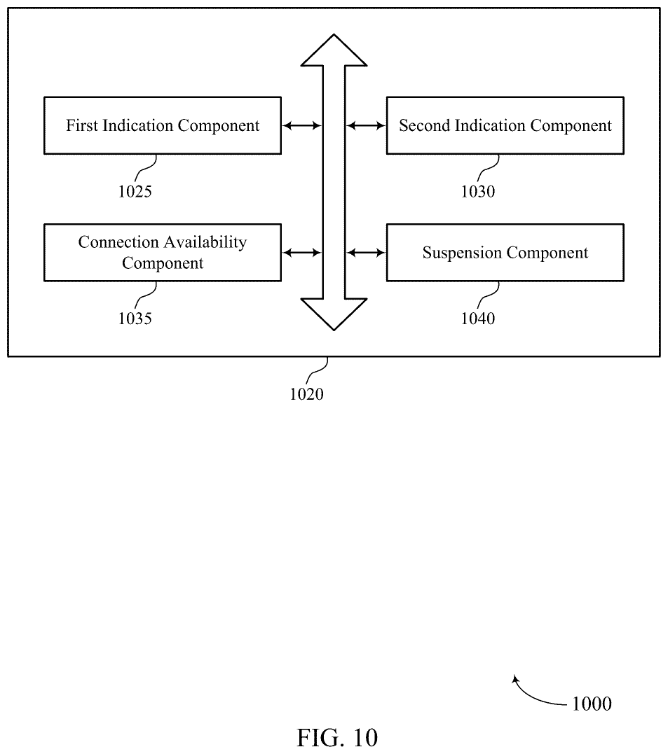

FIG. 10 shows a block diagram 1000 of a communications manager 1020 that supports mobile integrated access and backhaul procedures based on interface availability in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of mobile integrated access and backhaul procedures based on interface availability as described herein. For example, the communications manager 1020 may include a first indication component 1025, a second indication component 1030, a connection availability component 1035, a suspension component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The first indication component 1025 is capable of, configured to, or operable to support a means for receiving a first indication of an identifier of a first CU that is connected to an access node via a backhaul UE interface connection. The second indication component 1030 is capable of, configured to, or operable to support a means for transmitting a second indication to the access node to suspend a backhaul network entity interface connection between the access node and the second CU, where the second indication to suspend the backhaul network entity interface connection is based on an inter-CU backhaul connection being unavailable between the second CU and the first CU.

In some examples, to support receiving the first indication, the first indication component 1025 is capable of, configured to, or operable to support a means for receiving the first indication from the access node.

In some examples, to support receiving the first indication, the first indication component 1025 is capable of, configured to, or operable to support a means for receiving the first indication from a CU that terminates the backhaul UE interface connection for the access node.

In some examples, the backhaul UE interface connection is an RRC connection.

In some examples, to support receiving the first indication, the first indication component 1025 is capable of, configured to, or operable to support a means for receiving the first indication prior to an establishment of the backhaul UE interface connection, where the first indication is associated with establishment of the backhaul UE interface connection to the first CU.

In some examples, the connection availability component 1035 is capable of, configured to, or operable to support a means for determining that the inter-CU backhaul connection is unavailable based on a determination that inter-CU backhaul connectivity cannot be established.

In some examples, the first indication includes a request to perform suspension of the backhaul network entity interface connection between the access node and the second CU indicated by the second indication.

In some examples, the suspension component 1040 is capable of, configured to, or operable to support a means for suspending the backhaul network entity interface connection between the second CU and the access node by performing a release of the backhaul network entity interface connection.

In some examples, the backhaul network entity interface connection between the second CU and the access node is an F1 connection.

In some examples, the suspension component 1040 is capable of, configured to, or operable to support a means for suspending the backhaul network entity interface connection between the second CU and the access node by rejecting a connection setup procedure initiated by the access node to the second CU. In some examples, the suspension component 1040 is capable of, configured to, or operable to support a means for transmitting a rejection message indicating a redirection of the connection setup procedure to a different CU.

In some examples, the suspension component 1040 is capable of, configured to, or operable to support a means for suspending the backhaul network entity interface connection between the second CU and the access node by triggering an establishment of a second backhaul network entity interface connection between the access node and a different CU than the second CU.

In some examples, the second indication indicates a cause value associated with unavailability of the inter-CU backhaul connection between the second CU and the first CU.

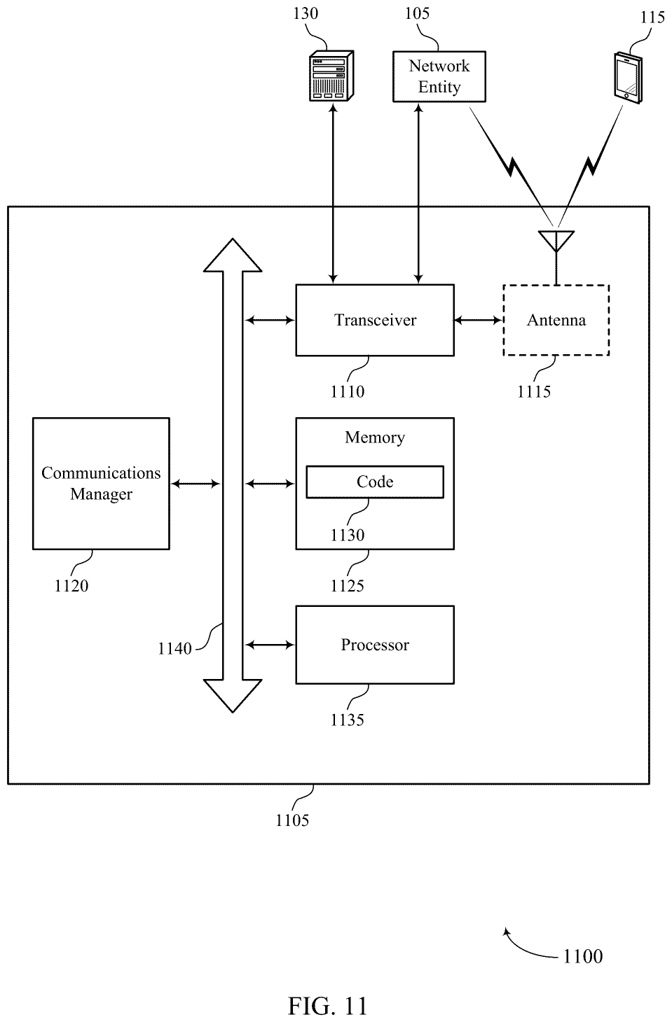

FIG. 11 shows a diagram of a system 1100 including a device 1105 that supports mobile integrated access and backhaul procedures based on interface availability in accordance with one or more aspects of the present disclosure. The device 1105 may be an example of or include the components of a device 805, a device 905, or a second CU as described herein. The device 1105 may include components for bi-directional voice and data communications including components for transmitting and receiving communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting mobile integrated access and backhaul procedures based on interface availability). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for receiving a first indication of an identifier of a first CU that is connected to an access node via a backhaul UE interface connection. The communications manager 1120 is capable of, configured to, or operable to support a means for transmitting a second indication to the access node to suspend a backhaul network entity interface connection between the access node and the second CU, where the second indication to suspend the backhaul network entity interface connection is based on an inter-CU backhaul connection being unavailable between the second CU and the first CU.

By including or configuring the communications manager 1120 in accordance with examples as described herein, the device 1105 may support techniques for improved communication reliability, reduced latency, more efficient utilization of communication resources, improved coordination between devices, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of mobile integrated access and backhaul procedures based on interface availability as described herein, or the at least one processor 1135 and the at least one memory 1125 may be otherwise configured to, individually or collectively, perform or support such operations.

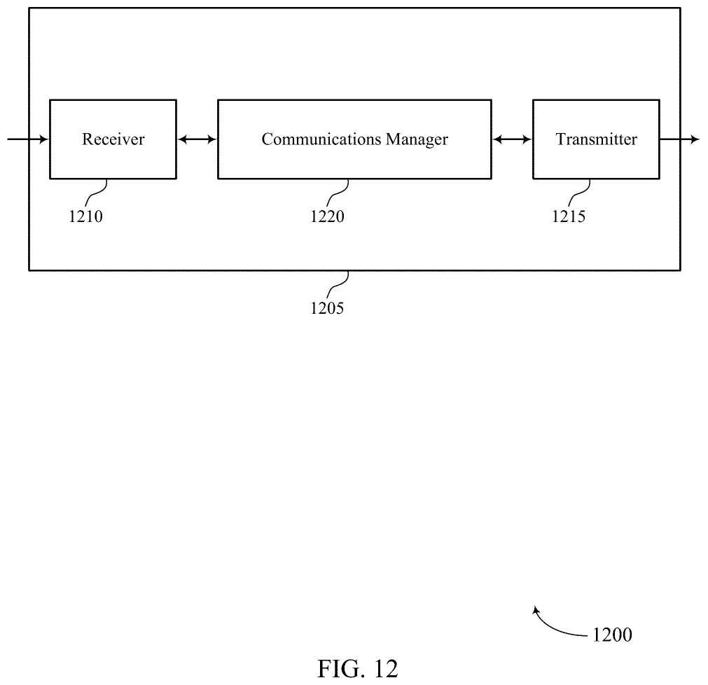

FIG. 12 shows a block diagram 1200 of a device 1205 that supports mobile integrated access and backhaul procedures based on interface availability in accordance with one or more aspects of the present disclosure. The device 1205 may be an example of aspects of an access node as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of mobile integrated access and backhaul procedures based on interface availability as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for establishing a backhaul UE interface connection with a first CU. The communications manager 1220 is capable of, configured to, or operable to support a means for transmitting an identifier of the first CU to a second CU associated with a backhaul network entity interface connection between the second CU and the access node. The communications manager 1220 is capable of, configured to, or operable to support a means for receiving, in response to transmitting the identifier of the first CU, an indication to suspend the backhaul network entity interface connection between the second CU and the access node.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources.

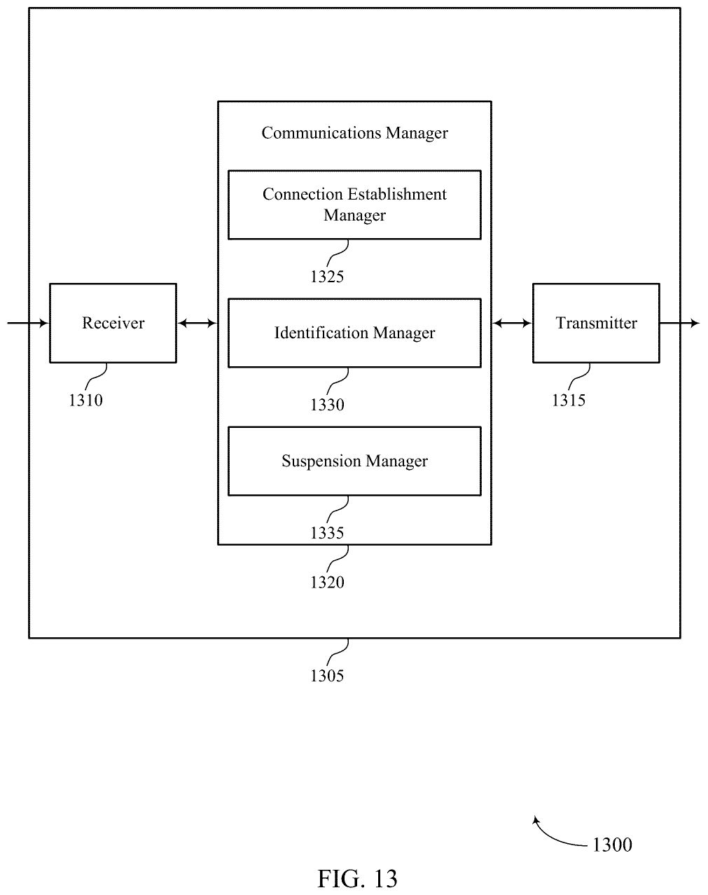

FIG. 13 shows a block diagram 1300 of a device 1305 that supports mobile integrated access and backhaul procedures based on interface availability in accordance with one or more aspects of the present disclosure. The device 1305 may be an example of aspects of a device 1205 or an access node as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of mobile integrated access and backhaul procedures based on interface availability as described herein. For example, the communications manager 1320 may include a connection establishment manager 1325, an identification manager 1330, a suspension manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The connection establishment manager 1325 is capable of, configured to, or operable to support a means for establishing a backhaul UE interface connection with a first CU. The identification manager 1330 is capable of, configured to, or operable to support a means for transmitting an identifier of the first CU to a second CU associated with a backhaul network entity interface connection between the second CU and the access node. The suspension manager 1335 is capable of, configured to, or operable to support a means for receiving, in response to transmitting the identifier of the first CU, an indication to suspend the backhaul network entity interface connection between the second CU and the access node.

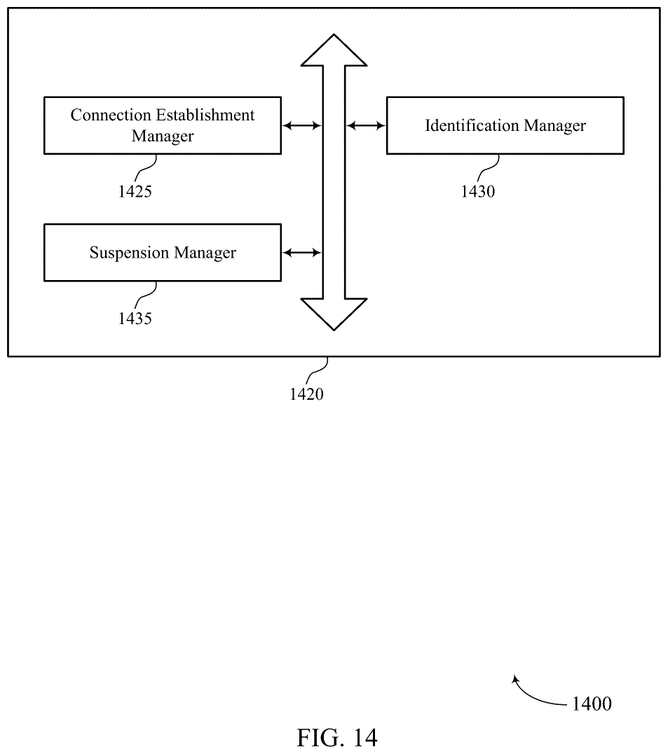

FIG. 14 shows a block diagram 1400 of a communications manager 1420 that supports mobile integrated access and backhaul procedures based on interface availability in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of mobile integrated access and backhaul procedures based on interface availability as described herein. For example, the communications manager 1420 may include a connection establishment manager 1425, an identification manager 1430, a suspension manager 1435, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The connection establishment manager 1425 is capable of, configured to, or operable to support a means for establishing a backhaul UE interface connection with a first CU. The identification manager 1430 is capable of, configured to, or operable to support a means for transmitting an identifier of the first CU to a second CU associated with a backhaul network entity interface connection between the second CU and the access node. The suspension manager 1435 is capable of, configured to, or operable to support a means for receiving, in response to transmitting the identifier of the first CU, an indication to suspend the backhaul network entity interface connection between the second CU and the access node.

In some examples, the backhaul UE interface connection is an RRC connection and the backhaul network entity interface connection is an F1 connection.

In some examples, the identifier is transmitted in association with a request to establish the backhaul network entity interface connection.

In some examples, the indication to suspend the backhaul network entity interface connection includes a rejection message indicating a redirection of a connection setup procedure to a different CU than the second CU.

In some examples, the indication to suspend the backhaul network entity interface connection includes a trigger to establish a second backhaul network entity interface connection between the access node and a different CU than the second CU.

In some examples, the indication to suspend the backhaul network entity interface connection includes a cause value indicating unavailability of an inter-CU backhaul connection between the first CU and the second CU.

In some examples, the suspension manager 1435 is capable of, configured to, or operable to support a means for transmitting, to a third CU, a message indicating suspension of the backhaul network entity interface connection between the second CU and the access node.

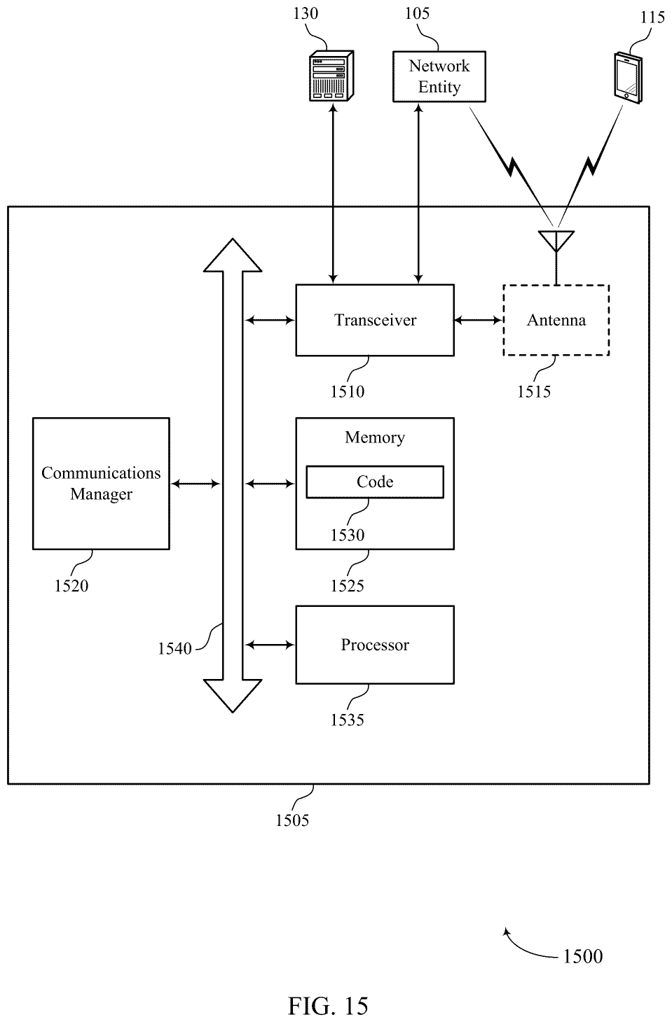

FIG. 15 shows a diagram of a system 1500 including a device 1505 that supports mobile integrated access and backhaul procedures based on interface availability in accordance with one or more aspects of the present disclosure. The device 1505 may be an example of or include the components of a device 1205, a device 1305, or an access node as described herein. The device 1505 may include components for bi-directional voice and data communications including components for transmitting and receiving communications, such as a communications manager 1520, a transceiver 1510, an antenna 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., a communication link 125, a backhaul communication link 120, a midhaul communication link 162, a fronthaul communication link 168).

The at least one memory 1525 may include RAM, ROM, or any combination thereof. The at least one memory 1525 may store computer-readable, computer-executable code 1530 including instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may contain, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting mobile integrated access and backhaul procedures based on interface availability). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525). In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. As such, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for establishing a backhaul UE interface connection with a first CU. The communications manager 1520 is capable of, configured to, or operable to support a means for transmitting an identifier of the first CU to a second CU associated with a backhaul network entity interface connection between the second CU and the access node. The communications manager 1520 is capable of, configured to, or operable to support a means for receiving, in response to transmitting the identifier of the first CU, an indication to suspend the backhaul network entity interface connection between the second CU and the access node.

By including or configuring the communications manager 1520 in accordance with examples as described herein, the device 1505 may support techniques for improved communication reliability, reduced latency, more efficient utilization of communication resources, improved coordination between devices, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of mobile integrated access and backhaul procedures based on interface availability as described herein, or the at least one processor 1535 and the at least one memory 1525 may be otherwise configured to, individually or collectively, perform or support such operations.

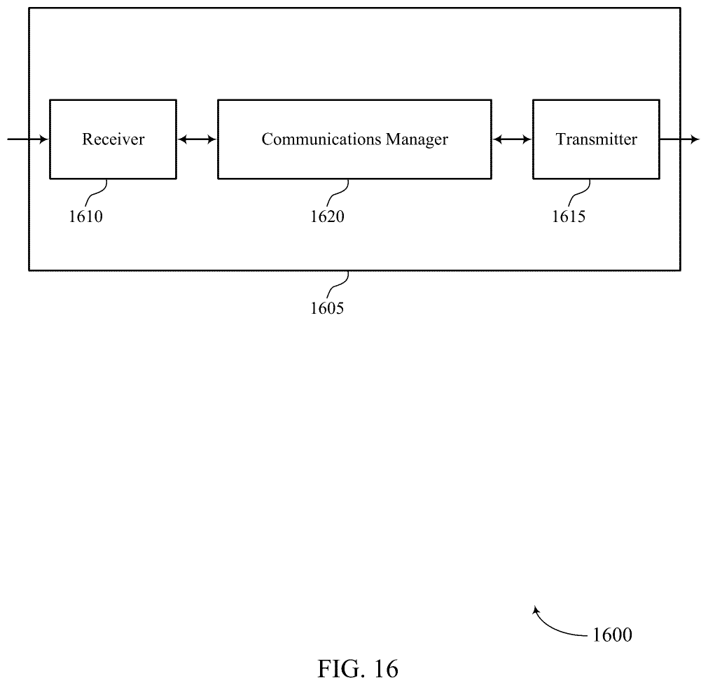

FIG. 16 shows a block diagram 1600 of a device 1605 that supports mobile integrated access and backhaul procedures based on interface availability in accordance with one or more aspects of the present disclosure. The device 1605 may be an example of aspects of a first CU as described herein. The device 1605 may include a receiver 1610, a transmitter 1615, and a communications manager 1620. The device 1605, or one or more components of the device 1605 (e.g., the receiver 1610, the transmitter 1615, and the communications manager 1620), may include at least one processor, which may be coupled with at least one memory, to, individually or collectively, support or enable the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations thereof or various components thereof may be examples of means for performing various aspects of mobile integrated access and backhaul procedures based on interface availability as described herein. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1620, the receiver 1610, the transmitter 1615, or various combinations or components thereof may be implemented in code (e.g., as communications management software or firmware) executed by at least one processor. If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. For example, the communications manager 1620 is capable of, configured to, or operable to support a means for establishing a backhaul UE interface connection with an access node. The communications manager 1620 is capable of, configured to, or operable to support a means for establishing a transport for a backhaul network entity interface connection of the access node with a second CU within a topology of the first CU. The communications manager 1620 is capable of, configured to, or operable to support a means for transmitting a message initiating a migration of the backhaul UE interface connection of the access node from the first CU to a third CU. The communications manager 1620 is capable of, configured to, or operable to support a means for receiving a first indication of unavailability of an inter-CU backhaul connection between the second CU and the third CU. The communications manager 1620 is capable of, configured to, or operable to support a means for transmitting a second indication to the second CU to release the backhaul network entity interface connection based on the first indication of unavailability of the inter-CU backhaul connection.

By including or configuring the communications manager 1620 in accordance with examples as described herein, the device 1605 (e.g., at least one processor controlling or otherwise coupled with the receiver 1610, the transmitter 1615, the communications manager 1620, or a combination thereof) may support techniques for more efficient utilization of communication resources.

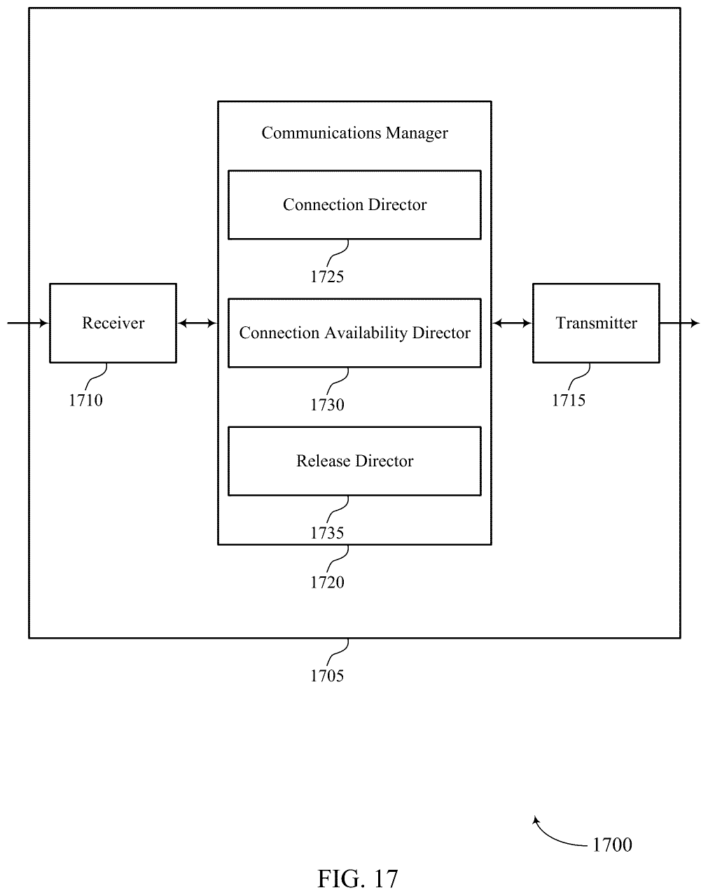

FIG. 17 shows a block diagram 1700 of a device 1705 that supports mobile integrated access and backhaul procedures based on interface availability in accordance with one or more aspects of the present disclosure. The device 1705 may be an example of aspects of a device 1605 or a first CU as described herein. The device 1705 may include a receiver 1710, a transmitter 1715, and a communications manager 1720. The device 1705, or one or more components of the device 1705 (e.g., the receiver 1710, the transmitter 1715, and the communications manager 1720), may include at least one processor, which may be coupled with at least one memory, to support the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of mobile integrated access and backhaul procedures based on interface availability as described herein. For example, the communications manager 1720 may include a connection director 1725, a connection availability director 1730, a release director 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications in accordance with examples as disclosed herein. The connection director 1725 is capable of, configured to, or operable to support a means for establishing a backhaul UE interface connection with an access node. The connection director 1725 is capable of, configured to, or operable to support a means for establishing a transport for a backhaul network entity interface connection of the access node with a second CU within a topology of the first CU. The connection director 1725 is capable of, configured to, or operable to support a means for transmitting a message initiating a migration of the backhaul UE interface connection of the access node from the first CU to a third CU. The connection availability director 1730 is capable of, configured to, or operable to support a means for receiving a first indication of unavailability of an inter-CU backhaul connection between the second CU and the third CU. The release director 1735 is capable of, configured to, or operable to support a means for transmitting a second indication to the second CU to release the backhaul network entity interface connection based on the first indication of unavailability of the inter-CU backhaul connection.

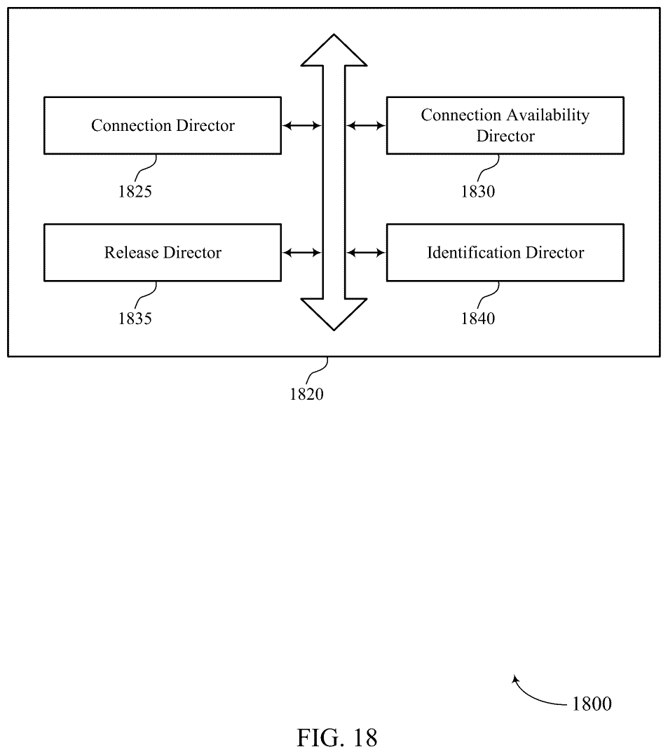

FIG. 18 shows a block diagram 1800 of a communications manager 1820 that supports mobile integrated access and backhaul procedures based on interface availability in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of mobile integrated access and backhaul procedures based on interface availability as described herein. For example, the communications manager 1820 may include a connection director 1825, a connection availability director 1830, a release director 1835, an identification director 1840, or any combination thereof. Each of these components, or components or subcomponents thereof (e.g., one or more processors, one or more memories), may communicate, directly or indirectly, with one another (e.g., via one or more buses).

The communications manager 1820 may support wireless communications in accordance with examples as disclosed herein. The connection director 1825 is capable of, configured to, or operable to support a means for establishing a backhaul UE interface connection with an access node. In some examples, the connection director 1825 is capable of, configured to, or operable to support a means for establishing a transport for a backhaul network entity interface connection of the access node with a second CU within a topology of the first CU. In some examples, the connection director 1825 is capable of, configured to, or operable to support a means for transmitting a message initiating a migration of the backhaul UE interface connection of the access node from the first CU to a third CU. The connection availability director 1830 is capable of, configured to, or operable to support a means for receiving a first indication of unavailability of an inter-CU backhaul connection between the second CU and the third CU. The release director 1835 is capable of, configured to, or operable to support a means for transmitting a second indication to the second CU to release the backhaul network entity interface connection based on the first indication of unavailability of the inter-CU backhaul connection.

In some examples, the backhaul UE interface connection is an RRC connection and the backhaul network entity interface connection is an F1 connection.

In some examples, the migration is a handover or a context retrieval for reestablishment.

In some examples, the message initiating the migration is carried on an Xn interface or an NG interface.

In some examples, the identification director 1840 is capable of, configured to, or operable to support a means for transmitting an identifier of the second CU to the third CU, where the first indication is received based on transmitting the identifier of the second CU.

In some examples, an indication of a connection release or a DU migration is communicated via the backhaul network entity interface connection.

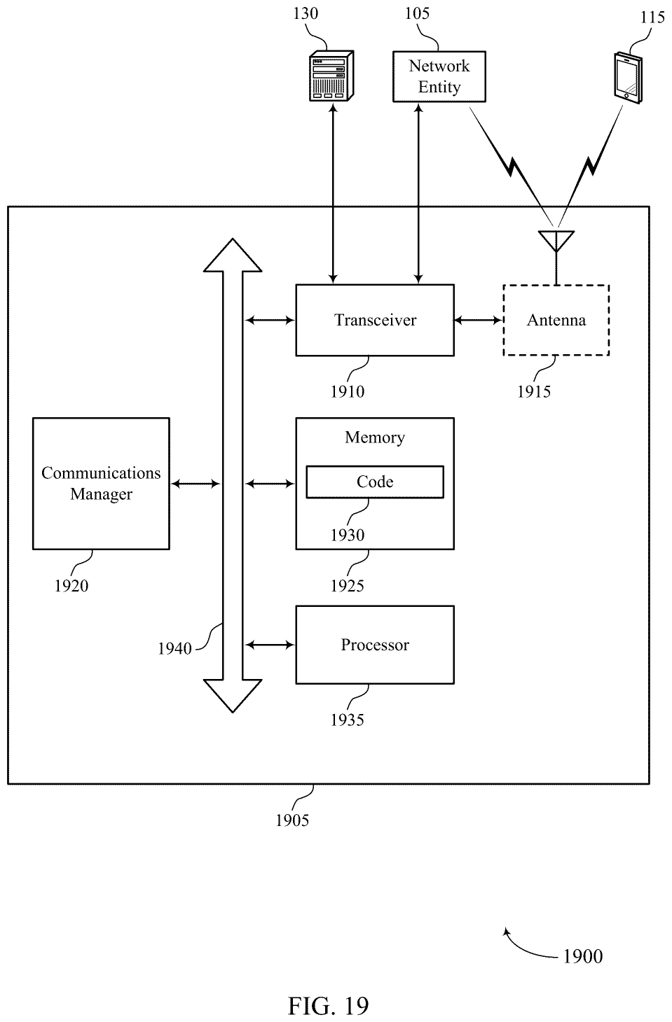

FIG. 19 shows a diagram of a system 1900 including a device 1905 that supports mobile integrated access and backhaul procedures based on interface availability in accordance with one or more aspects of the present disclosure. The device 1905 may be an example of or include the components of a device 1605, a device 1705, or a first CU as described herein. The device 1905 may include components for bi-directional voice and data communications including components for transmitting and receiving communications, such as a communications manager 1920, a transceiver 1910, an antenna 1915, at least one memory 1925, code 1930, and at least one processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or one or more memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or one or more memory components (e.g., the at least one processor 1935, the at least one memory 1925, or both), may be included in a chip or chip assembly that is installed in the device 1905. In some examples, the transceiver 1910 may be operable to support communications via one or more communications links (e.g., a communication link 125, a backhaul communication link 120, a midhaul communication link 162, a fronthaul communication link 168).

The at least one memory 1925 may include RAM, ROM, or any combination thereof. The at least one memory 1925 may store computer-readable, computer-executable code 1930 including instructions that, when executed by one or more of the at least one processor 1935, cause the device 1905 to perform various functions described herein. The code 1930 may be stored in a non-transitory computer-readable medium such as system memory or another type of memory. In some cases, the code 1930 may not be directly executable by a processor of the at least one processor 1935 but may cause a computer (e.g., when compiled and executed) to perform functions described herein. In some cases, the at least one memory 1925 may contain, among other things, a BIOS which may control basic hardware or software operation such as the interaction with peripheral components or devices. In some examples, the at least one processor 1935 may include multiple processors and the at least one memory 1925 may include multiple memories. One or more of the multiple processors may be coupled with one or more of the multiple memories which may, individually or collectively, be configured to perform various functions herein (for example, as part of a processing system).

The at least one processor 1935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1935 may be configured to operate a memory array using a memory controller. In some other cases, a memory controller may be integrated into one or more of the at least one processor 1935. The at least one processor 1935 may be configured to execute computer-readable instructions stored in a memory (e.g., one or more of the at least one memory 1925) to cause the device 1905 to perform various functions (e.g., functions or tasks supporting mobile integrated access and backhaul procedures based on interface availability). For example, the device 1905 or a component of the device 1905 may include at least one processor 1935 and at least one memory 1925 coupled with one or more of the at least one processor 1935, the at least one processor 1935 and the at least one memory 1925 configured to perform various functions described herein. The at least one processor 1935 may be an example of a cloud-computing platform (e.g., one or more physical nodes and supporting software such as operating systems, virtual machines, or container instances) that may host the functions (e.g., by executing code 1930) to perform the functions of the device 1905. The at least one processor 1935 may be any one or more suitable processors capable of executing scripts or instructions of one or more software programs stored in the device 1905 (such as within one or more of the at least one memory 1925). In some examples, the at least one processor 1935 may include multiple processors and the at least one memory 1925 may include multiple memories. One or more of the multiple processors may be coupled with one or more of the multiple memories, which may, individually or collectively, be configured to perform various functions herein. In some examples, the at least one processor 1935 may be a component of a processing system, which may refer to a system (such as a series) of machines, circuitry (including, for example, one or both of processor circuitry (which may include the at least one processor 1935) and memory circuitry (which may include the at least one memory 1925)), or components, that receives or obtains inputs and processes the inputs to produce, generate, or obtain a set of outputs. The processing system may be configured to perform one or more of the functions described herein. As such, the at least one processor 1935 or a processing system including the at least one processor 1935 may be configured to, configurable to, or operable to cause the device 1905 to perform one or more of the functions described herein. Further, as described herein, being “configured to,” being “configurable to,” and being “operable to” may be used interchangeably and may be associated with a capability, when executing code stored in the at least one memory 1925 or otherwise, to perform one or more of the functions described herein.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the at least one memory 1925, the code 1930, and the at least one processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with other network entities 105, and may include a controller or scheduler for controlling communications with UEs 115 in cooperation with other network entities 105. In some examples, the communications manager 1920 may support an X2 interface within an LTE/LTE-A wireless communications network technology to provide communication between network entities 105.

The communications manager 1920 may support wireless communications in accordance with examples as disclosed herein. For example, the communications manager 1920 is capable of, configured to, or operable to support a means for establishing a backhaul UE interface connection with an access node. The communications manager 1920 is capable of, configured to, or operable to support a means for establishing a transport for a backhaul network entity interface connection of the access node with a second CU within a topology of the first CU. The communications manager 1920 is capable of, configured to, or operable to support a means for transmitting a message initiating a migration of the backhaul UE interface connection of the access node from the first CU to a third CU. The communications manager 1920 is capable of, configured to, or operable to support a means for receiving a first indication of unavailability of an inter-CU backhaul connection between the second CU and the third CU. The communications manager 1920 is capable of, configured to, or operable to support a means for transmitting a second indication to the second CU to release the backhaul network entity interface connection based on the first indication of unavailability of the inter-CU backhaul connection.

By including or configuring the communications manager 1920 in accordance with examples as described herein, the device 1905 may support techniques for improved communication reliability, reduced latency, more efficient utilization of communication resources, improved coordination between devices, and improved utilization of processing capability.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. Although the communications manager 1920 is illustrated as a separate component, in some examples, one or more functions described with reference to the communications manager 1920 may be supported by or performed by the transceiver 1910, one or more of the at least one processor 1935, one or more of the at least one memory 1925, the code 1930, or any combination thereof (for example, by a processing system including at least a portion of the at least one processor 1935, the at least one memory 1925, the code 1930, or any combination thereof). For example, the code 1930 may include instructions executable by one or more of the at least one processor 1935 to cause the device 1905 to perform various aspects of mobile integrated access and backhaul procedures based on interface availability as described herein, or the at least one processor 1935 and the at least one memory 1925 may be otherwise configured to, individually or collectively, perform or support such operations.

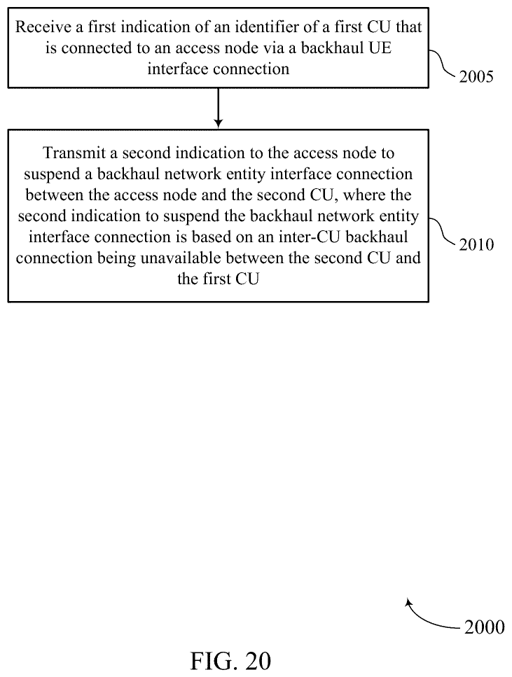

FIG. 20 shows a flowchart illustrating a method 2000 that supports mobile integrated access and backhaul procedures based on interface availability in accordance with aspects of the present disclosure. The operations of the method 2000 may be implemented by a second CU or its components as described herein. For example, the operations of the method 2000 may be performed by a second CU as described with reference to FIGS. 1 through 11. In some examples, a second CU may execute a set of instructions to control the functional elements of the second CU to perform the described functions. Additionally, or alternatively, the second CU may perform aspects of the described functions using special-purpose hardware.

At 2005, the method may include receiving a first indication of an identifier of a first CU that is connected to an access node via a backhaul UE interface connection. The operations of block 2005 may be performed in accordance with examples as disclosed herein. In some examples, aspects of the operations of 2005 may be performed by a first indication component 1025 as described with reference to FIG. 10.

At 2010, the method may include transmitting a second indication to the access node to suspend a backhaul network entity interface connection between the access node and the second CU, where the second indication to suspend the backhaul network entity interface connection is based on an inter-CU backhaul connection being unavailable between the second CU and the first CU. The operations of block 2010 may be performed in accordance with examples as disclosed herein. In some examples, aspects of the operations of 2010 may be performed by a second indication component 1030 as described with reference to FIG. 10.

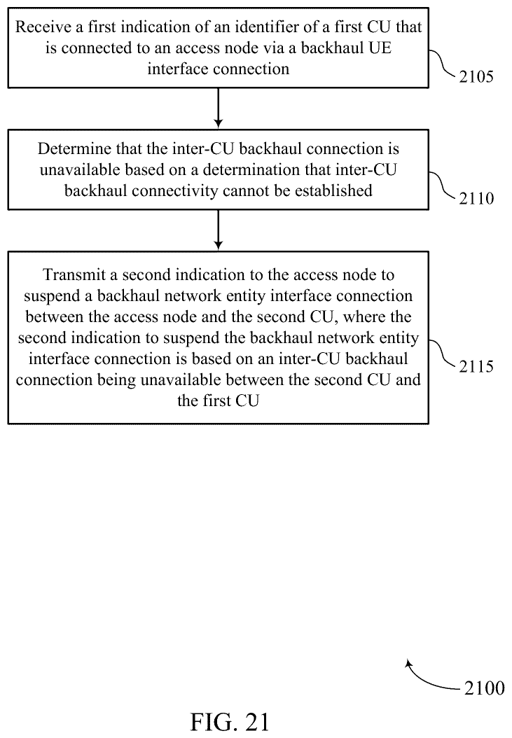

FIG. 21 shows a flowchart illustrating a method 2100 that supports mobile integrated access and backhaul procedures based on interface availability in accordance with aspects of the present disclosure. The operations of the method 2100 may be implemented by a second CU or its components as described herein. For example, the operations of the method 2100 may be performed by a second CU as described with reference to FIGS. 1 through 11. In some examples, a second CU may execute a set of instructions to control the functional elements of the second CU to perform the described functions. Additionally, or alternatively, the second CU may perform aspects of the described functions using special-purpose hardware.

At 2105, the method may include receiving a first indication of an identifier of a first CU that is connected to an access node via a backhaul UE interface connection. The operations of block 2105 may be performed in accordance with examples as disclosed herein. In some examples, aspects of the operations of 2105 may be performed by a first indication component 1025 as described with reference to FIG. 10.

At 2110, the method may include determining that the inter-CU backhaul connection is unavailable based on a determination that inter-CU backhaul connectivity cannot be established. The operations of block 2110 may be performed in accordance with examples as disclosed herein. In some examples, aspects of the operations of 2110 may be performed by a connection availability component 1035 as described with reference to FIG. 10.

At 2115, the method may include transmitting a second indication to the access node to suspend a backhaul network entity interface connection between the access node and the second CU, where the second indication to suspend the backhaul network entity interface connection is based on an inter-CU backhaul connection being unavailable between the second CU and the first CU. The operations of block 2115 may be performed in accordance with examples as disclosed herein. In some examples, aspects of the operations of 2115 may be performed by a second indication component 1030 as described with reference to FIG. 10.

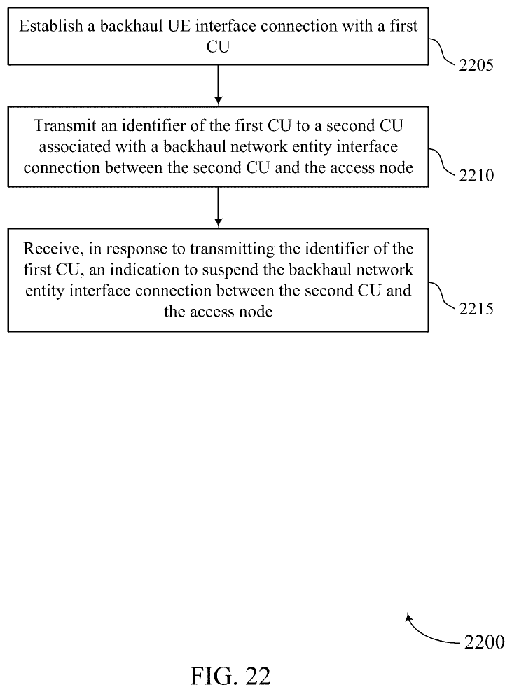

FIG. 22 shows a flowchart illustrating a method 2200 that supports mobile integrated access and backhaul procedures based on interface availability in accordance with aspects of the present disclosure. The operations of the method 2200 may be implemented by an access node or its components as described herein. For example, the operations of the method 2200 may be performed by an access node as described with reference to FIGS. 1 through 7 and 12 through 15. In some examples, an access node may execute a set of instructions to control the functional elements of the access node to perform the described functions. Additionally, or alternatively, the access node may perform aspects of the described functions using special-purpose hardware.

At 2205, the method may include establishing a backhaul UE interface connection with a first CU. The operations of block 2205 may be performed in accordance with examples as disclosed herein. In some examples, aspects of the operations of 2205 may be performed by a connection establishment manager 1425 as described with reference to FIG. 14.

At 2210, the method may include transmitting an identifier of the first CU to a second CU associated with a backhaul network entity interface connection between the second CU and the access node. The operations of block 2210 may be performed in accordance with examples as disclosed herein. In some examples, aspects of the operations of 2210 may be performed by an identification manager 1430 as described with reference to FIG. 14.

At 2215, the method may include receiving, in response to transmitting the identifier of the first CU, an indication to suspend the backhaul network entity interface connection between the second CU and the access node. The operations of block 2215 may be performed in accordance with examples as disclosed herein. In some examples, aspects of the operations of 2215 may be performed by a suspension manager 1435 as described with reference to FIG. 14.

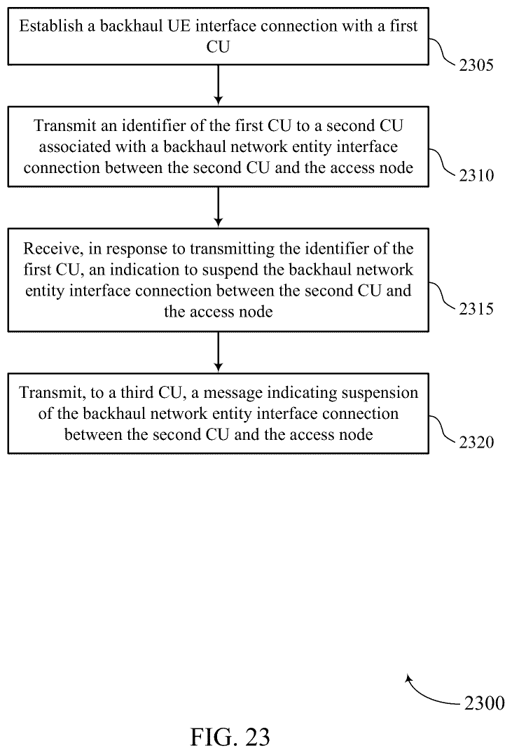

FIG. 23 shows a flowchart illustrating a method 2300 that supports mobile integrated access and backhaul procedures based on interface availability in accordance with aspects of the present disclosure. The operations of the method 2300 may be implemented by an access node or its components as described herein. For example, the operations of the method 2300 may be performed by an access node as described with reference to FIGS. 1 through 7 and 12 through 15. In some examples, an access node may execute a set of instructions to control the functional elements of the access node to perform the described functions. Additionally, or alternatively, the access node may perform aspects of the described functions using special-purpose hardware.

At 2305, the method may include establishing a backhaul UE interface connection with a first CU. The operations of block 2305 may be performed in accordance with examples as disclosed herein. In some examples, aspects of the operations of 2305 may be performed by a connection establishment manager 1425 as described with reference to FIG. 14.

At 2310, the method may include transmitting an identifier of the first CU to a second CU associated with a backhaul network entity interface connection between the second CU and the access node. The operations of block 2310 may be performed in accordance with examples as disclosed herein. In some examples, aspects of the operations of 2310 may be performed by an identification manager 1430 as described with reference to FIG. 14.

At 2315, the method may include receiving, in response to transmitting the identifier of the first CU, an indication to suspend the backhaul network entity interface connection between the second CU and the access node. The operations of block 2315 may be performed in accordance with examples as disclosed herein. In some examples, aspects of the operations of 2315 may be performed by a suspension manager 1435 as described with reference to FIG. 14.

At 2320, the method may include transmitting, to a third CU, a message indicating suspension of the backhaul network entity interface connection between the second CU and the access node. The operations of block 2320 may be performed in accordance with examples as disclosed herein. In some examples, aspects of the operations of 2320 may be performed by a suspension manager 1435 as described with reference to FIG. 14.

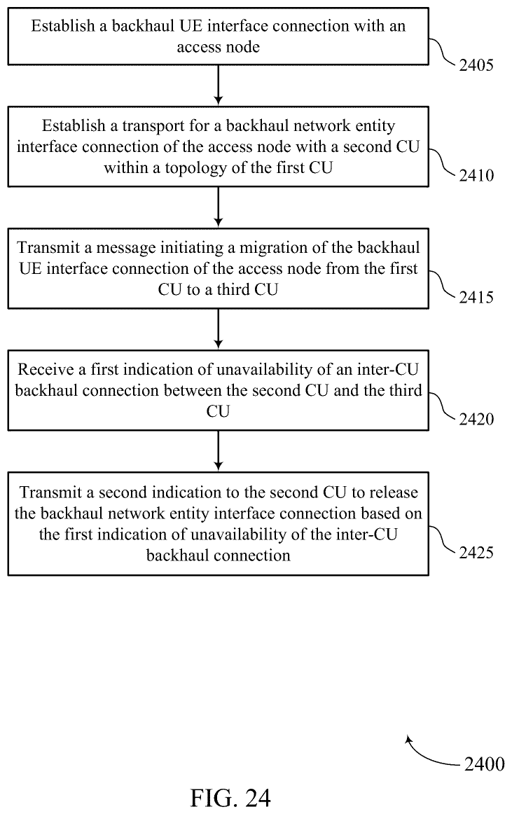

FIG. 24 shows a flowchart illustrating a method 2400 that supports mobile integrated access and backhaul procedures based on interface availability in accordance with aspects of the present disclosure. The operations of the method 2400 may be implemented by a first CU or its components as described herein. For example, the operations of the method 2400 may be performed by a first CU as described with reference to FIGS. 1 through 7 and 16 through 19. In some examples, a first CU may execute a set of instructions to control the functional elements of the first CU to perform the described functions. Additionally, or alternatively, the first CU may perform aspects of the described functions using special-purpose hardware.

At 2405, the method may include establishing a backhaul UE interface connection with an access node. The operations of block 2405 may be performed in accordance with examples as disclosed herein. In some examples, aspects of the operations of 2405 may be performed by a connection director 1825 as described with reference to FIG. 18.

At 2410, the method may include establishing a transport for a backhaul network entity interface connection of the access node with a second CU within a topology of the first CU. The operations of block 2410 may be performed in accordance with examples as disclosed herein. In some examples, aspects of the operations of 2410 may be performed by a connection director 1825 as described with reference to FIG. 18.

At 2415, the method may include transmitting a message initiating a migration of the backhaul UE interface connection of the access node from the first CU to a third CU. The operations of block 2415 may be performed in accordance with examples as disclosed herein. In some examples, aspects of the operations of 2415 may be performed by a connection director 1825 as described with reference to FIG. 18.

At 2420, the method may include receiving a first indication of unavailability of an inter-CU backhaul connection between the second CU and the third CU. The operations of block 2420 may be performed in accordance with examples as disclosed herein. In some examples, aspects of the operations of 2420 may be performed by a connection availability director 1830 as described with reference to FIG. 18.

At 2425, the method may include transmitting a second indication to the second CU to release the backhaul network entity interface connection based on the first indication of unavailability of the inter-CU backhaul connection. The operations of block 2425 may be performed in accordance with examples as disclosed herein. In some examples, aspects of the operations of 2425 may be performed by a release director 1835 as described with reference to FIG. 18.

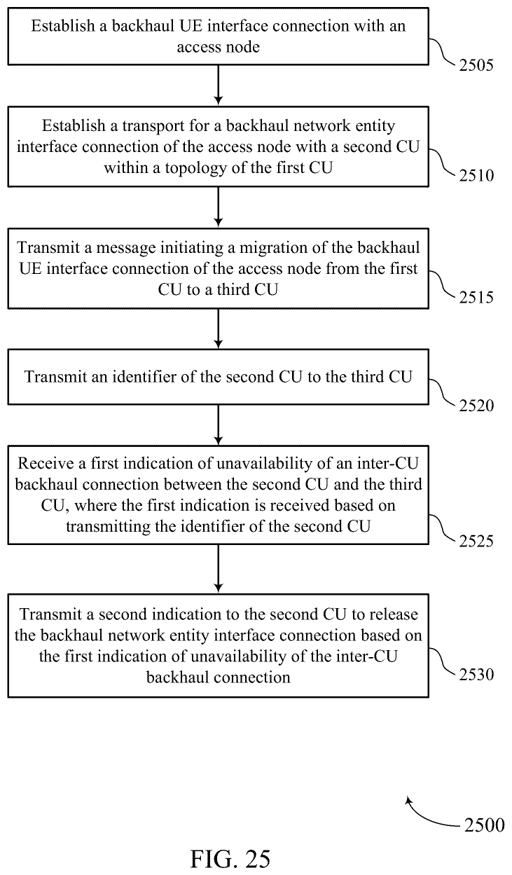

FIG. 25 shows a flowchart illustrating a method 2500 that supports mobile integrated access and backhaul procedures based on interface availability in accordance with aspects of the present disclosure. The operations of the method 2500 may be implemented by a first CU or its components as described herein. For example, the operations of the method 2500 may be performed by a first CU as described with reference to FIGS. 1 through 7 and 16 through 19. In some examples, a first CU may execute a set of instructions to control the functional elements of the first CU to perform the described functions. Additionally, or alternatively, the first CU may perform aspects of the described functions using special-purpose hardware.

At 2505, the method may include establishing a backhaul UE interface connection with an access node. The operations of block 2505 may be performed in accordance with examples as disclosed herein. In some examples, aspects of the operations of 2505 may be performed by a connection director 1825 as described with reference to FIG. 18.

At 2510, the method may include establishing a transport for a backhaul network entity interface connection of the access node with a second CU within a topology of the first CU. The operations of block 2510 may be performed in accordance with examples as disclosed herein. In some examples, aspects of the operations of 2510 may be performed by a connection director 1825 as described with reference to FIG. 18.

At 2515, the method may include transmitting a message initiating a migration of the backhaul UE interface connection of the access node from the first CU to a third CU. The operations of block 2515 may be performed in accordance with examples as disclosed herein. In some examples, aspects of the operations of 2515 may be performed by a connection director 1825 as described with reference to FIG. 18.

At 2520, the method may include transmitting an identifier of the second CU to the third CU. The operations of block 2520 may be performed in accordance with examples as disclosed herein. In some examples, aspects of the operations of 2520 may be performed by an identification director 1840 as described with reference to FIG. 18.

At 2525, the method may include receiving a first indication of unavailability of an inter-CU backhaul connection between the second CU and the third CU, where the first indication is received based on transmitting the identifier of the second CU. The operations of block 2525 may be performed in accordance with examples as disclosed herein. In some examples, aspects of the operations of 2525 may be performed by a connection availability director 1830 as described with reference to FIG. 18.

At 2530, the method may include transmitting a second indication to the second CU to release the backhaul network entity interface connection based on the first indication of unavailability of the inter-CU backhaul connection. The operations of block 2530 may be performed in accordance with examples as disclosed herein. In some examples, aspects of the operations of 2530 may be performed by a release director 1835 as described with reference to FIG. 18.

The following provides an overview of aspects of the present disclosure:

Aspect 1: A method for wireless communications by a second CU, comprising: receiving a first indication of an identifier of a first CU that is connected to an access node via a backhaul UE interface connection; and transmitting a second indication to the access node to suspend a backhaul network entity interface connection between the access node and the second CU, wherein the second indication to suspend the backhaul network entity interface connection is based at least in part on an inter-CU backhaul connection being unavailable between the second CU and the first CU.

Aspect 2: The method of aspect 1, wherein receiving the first indication comprises: receiving the first indication from the access node.

Aspect 3: The method of aspect 1, wherein receiving the first indication comprises: receiving the first indication from a CU that terminates the backhaul UE interface connection for the access node.

Aspect 4: The method of any of aspects 1 through 3, wherein the backhaul UE interface connection is an RRC connection.

Aspect 5: The method of any of aspects 1 through 4, wherein receiving the first indication comprises: receiving the first indication prior to an establishment of the backhaul UE interface connection, wherein the first indication is associated with establishment of the backhaul UE interface connection to the first CU.

Aspect 6: The method of any of aspects 1 through 5, further comprising: determining that the inter-CU backhaul connection is unavailable based at least in part on a determination that inter-CU backhaul connectivity cannot be established.

Aspect 7: The method of any of aspects 1 through 6, wherein the first indication comprises a request to perform suspension of the backhaul network entity interface connection between the access node and the second CU indicated by the second indication.

Aspect 8: The method of any of aspects 1 through 7, further comprising: suspending the backhaul network entity interface connection between the second CU and the access node by performing a release of the backhaul network entity interface connection.

Aspect 9: The method of aspect 8, wherein the backhaul network entity interface connection between the second CU and the access node is an F1 connection.

Aspect 10: The method of any of aspects 1 through 7, further comprising: suspending the backhaul network entity interface connection between the second CU and the access node by rejecting a connection setup procedure initiated by the access node to the second CU; and transmitting a rejection message indicating a redirection of the connection setup procedure to a different CU.

Aspect 11: The method of any of aspects 1 through 10, further comprising: suspending the backhaul network entity interface connection between the second CU and the access node by triggering an establishment of a second backhaul network entity interface connection between the access node and a different CU than the second CU.

Aspect 12: The method of any of aspects 1 through 11, wherein the second indication indicates a cause value associated with unavailability of the inter-CU backhaul connection between the second CU and the first CU.

Aspect 13: A method for wireless communications by an access node, comprising: establishing a backhaul UE interface connection with a first CU; transmitting an identifier of the first CU to a second CU associated with a backhaul network entity interface connection between the second CU and the access node; and receiving, in response to transmitting the identifier of the first CU, an indication to suspend the backhaul network entity interface connection between the second CU and the access node.

Aspect 14: The method of aspect 13, wherein the backhaul UE interface connection is an RRC connection and the backhaul network entity interface connection is an F1 connection.

Aspect 15: The method of any of aspects 13 through 14, wherein the identifier is transmitted in association with a request to establish the backhaul network entity interface connection.

Aspect 16: The method of any of aspects 13 through 15, wherein the indication to suspend the backhaul network entity interface connection comprises a rejection message indicating a redirection of a connection setup procedure to a different CU than the second CU.

Aspect 17: The method of any of aspects 13 through 15, wherein the indication to suspend the backhaul network entity interface connection comprises a trigger to establish a second backhaul network entity interface connection between the access node and a different CU than the second CU.

Aspect 18: The method of any of aspects 13 through 17, wherein the indication to suspend the backhaul network entity interface connection comprises a cause value indicating unavailability of an inter-CU backhaul connection between the first CU and the second CU.

Aspect 19: The method of any of aspects 13 through 18, further comprising: transmitting, to a third CU, a message indicating suspension of the backhaul network entity interface connection between the second CU and the access node.

Aspect 20: A method for wireless communications by a first CU, comprising: establishing a backhaul UE interface connection with an access node; establishing a transport for a backhaul network entity interface connection of the access node with a second CU within a topology of the first CU; transmitting a message initiating a migration of the backhaul UE interface connection of the access node from the first CU to a third CU; receiving a first indication of unavailability of an inter-CU backhaul connection between the second CU and the third CU; and transmitting a second indication to the second CU to release the backhaul network entity interface connection based at least in part on the first indication of unavailability of the inter-CU backhaul connection.

Aspect 21: The method of aspect 20, wherein the backhaul UE interface connection is an RRC connection and the backhaul network entity interface connection is an F1 connection.

Aspect 22: The method of any of aspects 20 through 21, wherein the migration is a handover or a context retrieval for reestablishment.

Aspect 23: The method of any of aspects 20 through 22, wherein the message initiating the migration is carried on an Xn interface or an NG interface.

Aspect 24: The method of any of aspects 20 through 23, further comprising: transmitting an identifier of the second CU to the third CU, wherein the first indication is received based at least in part on transmitting the identifier of the second CU.

Aspect 25: The method of any of aspects 20 through 24, wherein an indication of a connection release or a DU migration is communicated via the backhaul network entity interface connection.

Aspect 26: A second CU for wireless communications, comprising one or more memories storing processor-executable code, and one or more processors coupled with the one or more memories and individually or collectively operable to execute the code to cause the second CU to perform a method of any of aspects 1 through 12.

Aspect 27: A second CU for wireless communications, comprising at least one means for performing a method of any of aspects 1 through 12.

Aspect 28: A non-transitory computer-readable medium storing code for wireless communications, the code comprising instructions executable by a processor to perform a method of any of aspects 1 through 12.

Aspect 29: An access node for wireless communications, comprising one or more memories storing processor-executable code, and one or more processors coupled with the one or more memories and individually or collectively operable to execute the code to cause the access node to perform a method of any of aspects 13 through 19.

Aspect 30: An access node for wireless communications, comprising at least one means for performing a method of any of aspects 13 through 19.

Aspect 31: A non-transitory computer-readable medium storing code for wireless communications, the code comprising instructions executable by a processor to perform a method of any of aspects 13 through 19.

Aspect 32: A first CU for wireless communications, comprising one or more memories storing processor-executable code, and one or more processors coupled with the one or more memories and individually or collectively operable to execute the code to cause the first CU to perform a method of any of aspects 20 through 25.

Aspect 33: A first CU for wireless communications, comprising at least one means for performing a method of any of aspects 20 through 25.

Aspect 34: A non-transitory computer-readable medium storing code for wireless communications, the code comprising instructions executable by a processor to perform a method of any of aspects 20 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A second central unit (CU), comprising:
one or more memories storing processor-executable code; and
one or more processors coupled with the one or more memories and individually or collectively operable to execute the code to cause the second CU to:
receive a first indication of an identifier of a first CU that is connected to an access node via a backhaul user equipment (UE) interface connection; and
transmit a second indication to the access node to suspend a backhaul network entity interface connection between the access node and the second CU, wherein the second indication to suspend the backhaul network entity interface connection is based at least in part on an inter-CU backhaul connection being unavailable between the second CU and the first CU.

2. The second CU of claim 1, wherein, to receive the first indication, the one or more processors are individually or collectively operable to execute the code to cause the second CU to:
receive the first indication from the access node.

3. The second CU of claim 1, wherein, to receive the first indication, the one or more processors are individually or collectively operable to execute the code to cause the second CU to:
receive the first indication from a CU that terminates the backhaul UE interface connection for the access node.

4. The second CU of claim 1, wherein the backhaul UE interface connection is a radio resource control (RRC) connection.

5. The second CU of claim 1, wherein, to receive the first indication, the one or more processors are individually or collectively operable to execute the code to cause the second CU to:
receive the first indication prior to an establishment of the backhaul UE interface connection, wherein the first indication is associated with establishment of the backhaul UE interface connection to the first CU.

6. The second CU of claim 1, wherein the one or more processors are individually or collectively further operable to execute the code to cause the second CU to:
determine that the inter-CU backhaul connection is unavailable based at least in part on a determination that inter-CU backhaul connectivity cannot be established.

7. The second CU of claim 1, wherein the first indication comprises a request to perform suspension of the backhaul network entity interface connection between the access node and the second CU indicated by the second indication.

8. The second CU of claim 1, wherein the one or more processors are individually or collectively further operable to execute the code to cause the second CU to:
suspend the backhaul network entity interface connection between the second CU and the access node by performing a release of the backhaul network entity interface connection.

9. The second CU of claim 8, wherein the backhaul network entity interface connection between the second CU and the access node is an F1 connection.

10. The second CU of claim 1, wherein the one or more processors are individually or collectively further operable to execute the code to cause the second CU to:
suspend the backhaul network entity interface connection between the second CU and the access node by rejecting a connection setup procedure initiated by the access node to the second CU; and
transmit a rejection message indicating a redirection of the connection setup procedure to a different CU.

11. The second CU of claim 1, wherein the one or more processors are individually or collectively further operable to execute the code to cause the second CU to:
suspend the backhaul network entity interface connection between the second CU and the access node by triggering an establishment of a second backhaul network entity interface connection between the access node and a different CU than the second CU.

12. The second CU of claim 1, wherein the second indication indicates a cause value associated with unavailability of the inter-CU backhaul connection between the second CU and the first CU.

13. An access node, comprising:
one or more memories storing processor-executable code; and
one or more processors coupled with the one or more memories and individually or collectively operable to execute the code to cause the access node to:
establish a backhaul UE interface connection with a first central unit (CU);
transmit an identifier of the first CU to a second CU associated with a backhaul network entity interface connection between the second CU and the access node; and
receive, in response to transmitting the identifier of the first CU, an indication to suspend the backhaul network entity interface connection between the second CU and the access node.

14. The access node of claim 13, wherein the backhaul UE interface connection is a radio resource control (RRC) connection and the backhaul network entity interface connection is an F1 connection.

15. The access node of claim 13, wherein the identifier is transmitted in association with a request to establish the backhaul network entity interface connection.

16. The access node of claim 13, wherein the indication to suspend the backhaul network entity interface connection comprises a rejection message indicating a redirection of a connection setup procedure to a different CU than the second CU.

17. The access node of claim 13, wherein the indication to suspend the backhaul network entity interface connection comprises a trigger to establish a second backhaul network entity interface connection between the access node and a different CU than the second CU.

18. The access node of claim 13, wherein the indication to suspend the backhaul network entity interface connection comprises a cause value indicating unavailability of an inter-CU backhaul connection between the first CU and the second CU.

19. The access node of claim 13, wherein the one or more processors are individually or collectively further operable to execute the code to cause the access node to:
transmit, to a third CU, a message indicating suspension of the backhaul network entity interface connection between the second CU and the access node.

20. A method for wireless communications by a second central unit (CU), comprising:
receiving a first indication of an identifier of a first CU that is connected to an access node via a backhaul user equipment (UE) interface connection; and
transmitting a second indication to the access node to suspend a backhaul network entity interface connection between the access node and the second CU, wherein the second indication to suspend the backhaul network entity interface connection is based at least in part on an inter-CU backhaul connection being unavailable between the second CU and the first CU.
